(19) United States
(12) Patent Application Publication
(10) Pub. No.: US 2024/0416714 A1
(43) Pub. Date: Dec. 19, 2024

(54) VEHICLE SEAT AIR CONDITIONING DEVICE

(71) Applicant: Panasonic Automotive Systems Co., Ltd., Kanagawa (JP)

(72) Inventors: Yuki MAKITA, Kanagawa (JP); Takeshi ENYA, Osaka (JP); Tatehiko INOUE, Osaka (JP); Yoshihiko MAEDA, Hyogo (JP); Takuya NAKAGAWA, Shiga (JP)

(21) Appl. No.: 18/820,999

(22) Filed: Aug. 30, 2024

Related U.S. Application Data
(63) Continuation of application No. PCT/JP2023/005262, filed on Feb. 15, 2023.

(30) Foreign Application Priority Data
Mar. 3, 2022 (JP) 2022-032675
Sep. 30, 2022 (JP) 2022-158988

(51) Int. Cl. B60H 1/00

(52) U.S. Cl. CPC B60H 1/00285

(57) ABSTRACT

A vehicle seat air conditioning device includes: a fan built in a seat; a controller that controls the fan; and an outlet that blows out air from the surface of a seat back, where the air is guided through a flow path formed in the seat back. The outlet is provided with a wind direction adjuster including one or more plates that adjust the direction of air blown out from the outlet. The one or more plates are disposed in an orientation completely or substantially parallel to or tilted with respect to the central axis of the flow path along which air to be blown out from the outlet flows. The controller controls the rate of rotation of the fan based on a first temperature that is a temperature inside a vehicle and a second temperature that is the temperature of air blown out from the outlet.

### CROSS REFERENCE TO RELATED APPLICATIONS

This is a continuation application of PCT International Application No. PCT/JP2023/005262 filed on Feb. 15, 2023, designating the United States of America, which is based on and claims priority of Japanese Patent Application No. 2022-032675 filed on Mar. 3, 2022 and Japanese Patent Application No. 2022-158988 filed on Sep. 30, 2022.

### FIELD

The present disclosure relates to a vehicle seat air conditioning device that sends air to a person seated on a seat.

### BACKGROUND

In recent years, there has been a demand for providing a comfortable air-conditioned environment to a person seated on a seat.

For example, Patent Literature (PTL) 1 discloses a vehicle seat air conditioning device including a fan that sends air, a heat exchanger that heats or cools the air sent by the fan, an air blower that is open to inside a vehicle and blows out the air introduced from the heat exchanger, a first switch device that switches the air blower between a first blowing state in which air is blown to deviate from a space occupied by an occupant and a second blowing state in which air is blown toward the space occupied by an occupant, a controller that makes the air blower enter the first blowing state when a well-conditioned state is yet to be reached and makes the air blower enter the second blowing state when the well-conditioned state has been reached, and an actuator that rotates in accordance with a control signal from the controller.

### CITATION LIST

### Patent Literature

PTL 1: Japanese Patent No. 6044506

### SUMMARY

However, the vehicle seat air conditioning device according to PTL 1 can be improved upon.

In view of this, the present disclosure provides a vehicle seat air conditioning device capable of improving upon the above related art.

A vehicle seat air conditioning device according to one aspect of the present disclosure is for use in a seat including a seat back and a seat cushion, and includes: a fan built in the seat; a controller that controls the fan; and an outlet that blows out air from the surface of the seat back, where the air is sent by the fan and guided through a flow path formed in the seat back. The outlet is provided with a wind direction adjuster including one or more plates that adjust the direction of air blown out from the outlet. The one or more plates are disposed in an orientation completely or substantially parallel to or tilted with respect to the central axis of the flow path along which air to be blown out from the outlet flows. The controller controls the rate of rotation of the fan based on a first temperature that is a temperature inside a vehicle and a second temperature that is the temperature of air blown out from the outlet.

Note that the comprehensive or specific aspect can be implemented by any combination of a system, a method and an integrated circuit, for example.

The vehicle seat air conditioning device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view indicating an outer appearance of a seat provided with a vehicle seat air conditioning device according to Embodiment 1.

FIG. 2 is a cross-sectional view of the seat provided with the vehicle seat air conditioning device taken along the line II-II in FIG. 1.

FIG. 3 is a top view of the seat illustrating a blowing direction of air.

FIG. 4 is a block diagram illustrating the vehicle seat air conditioning device according to Embodiment 1.

FIG. 5A is a cross-sectional view illustrating a case where a plate of a wind direction adjuster is in an orientation approximately parallel to a central axis of a flow path in a housing.

FIG. 5B is a cross-sectional view illustrating a case where the plate of the wind direction adjuster is in an orientation tilted 30° in a fore-and-aft direction with respect to the central axis of the flow path in the housing.

FIG. 5C is a cross-sectional view illustrating a case where the plate of the wind direction adjuster is in an orientation tilted 45° in the fore-and-aft direction with respect to the central axis of the flow path in the housing.

FIG. 5D is a cross-sectional view illustrating area A and opening areas B1, B2, B3, and B4 of the wind direction adjuster.

FIG. 6A includes cross-sectional views illustrating a blowing direction of air when the volume of air is high and a blowing direction of air when the volume of air is low in the case where the plate of the wind direction adjuster is in an orientation approximately parallel to the central axis of the flow path in the housing.

FIG. 6B includes cross-sectional views illustrating a blowing direction of air when the volume of air is high and a blowing direction of air when the volume of air is low in the case where the plate of the wind direction adjuster is in an orientation tilted 30° with respect to the central axis of the flow path in the housing.

FIG. 6C includes cross-sectional views illustrating a blowing direction of air when the volume of air is high and a blowing direction of air when the volume of air is low in the case where the plate of the wind direction adjuster is in an orientation tilted 45° with respect to the central axis of the flow path in the housing.

FIG. 7 is a flowchart illustrating a process of the vehicle seat air conditioning device according to Embodiment 1.

FIG. 8A is a diagram illustrating a flow of air blown to a person when the volume of air blown out from an outlet is extremely low.

FIG. 8B is a diagram illustrating a flow of air blown to the person when the volume of air blown out from the outlet is high.

FIG. 8C is a diagram illustrating a flow of air blown to the person when the volume of air blown out from the outlet is low.

FIG. 8D is another diagram illustrating a flow of air blown to the person when the volume of air blown out from the outlet is high.

FIG. 8E is another diagram illustrating a flow of air blown to the person when the volume of air blown out from the outlet is low.

FIG. 8F is a diagram illustrating a wind direction adjuster according to Variation 1 of Embodiment 1.

FIG. 8G is a diagram illustrating orientations of a plate of the wind direction adjuster according to Variation 1 of Embodiment 1.

FIG. 8H is a top view of the seat illustrating blowing directions of air when an air conditioner starts a cooling operation.

FIG. 8I is a diagram illustrating a relationship between the volume of air and the orientation of the plate.

FIG. 8J is a diagram illustrating a wind direction adjuster according to Variation 2 of Embodiment 1.

FIG. 8K is a diagram illustrating a wind direction adjuster according to Variation 3 of Embodiment 1.

FIG. 8L is a diagram illustrating a wind direction adjuster according to Variation 4 of Embodiment 1.

FIG. 9 is a block diagram illustrating a vehicle seat air conditioning device according to Embodiment 2.

FIG. 10 is a flowchart illustrating a process of the vehicle seat air conditioning device according to Embodiment 2.

FIG. 11 is a flowchart illustrating a process of a vehicle seat air conditioning device according to Embodiment 3.

FIG. 12 is a flowchart illustrating a process of a vehicle seat air conditioning device according to Embodiment 4.

FIG. 13 is a flowchart illustrating a process of a vehicle seat air conditioning device according to Embodiment 5.

### DESCRIPTION OF EMBODIMENTS

Any embodiment described below represents a comprehensive or specific example. Numerical values, shapes, materials, components, arrangements and connections of components, steps, sequences of steps, and the like illustrated in the embodiments described below are merely examples, and are not intended to limit the present disclosure. Of the components described in the embodiments described below, components that are not recited in any of the independent claims will be described as optional components.

In the description of the embodiments described below, expressions such as “approximately rectangular or plate-like” are used. For example, the “approximately rectangular or plate-like” means not only completely rectangular or plate-like but also substantially rectangular or plate-like, that is, including an error of the order of several percents. Furthermore, the “approximately rectangular or plate-like” means a rectangle or plate that can achieve the effects of the present disclosure. The same holds true for other expressions including “approximately” and “-like”.

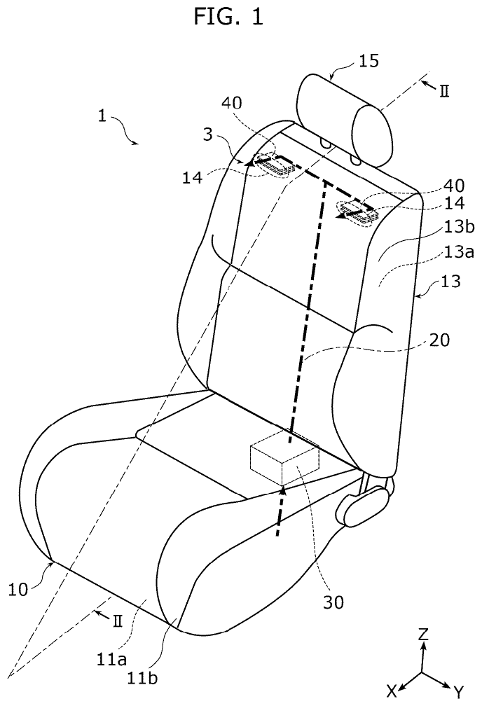

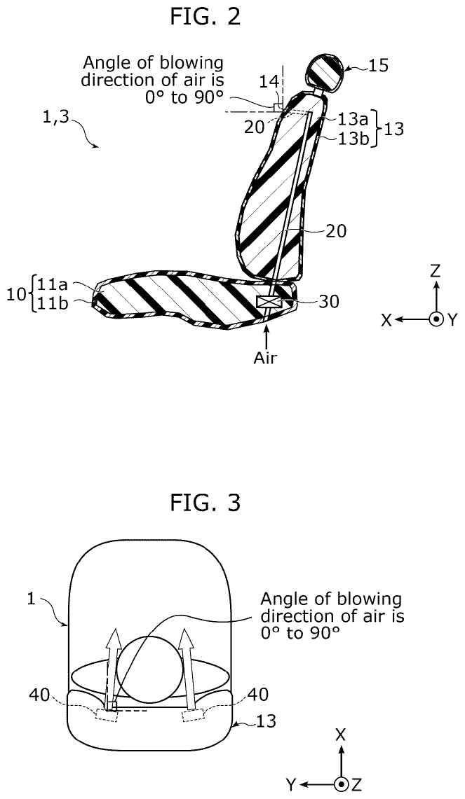

In the following description, the fore-and-aft direction of the seat will be referred to as an X-axis direction, and the up-and-down direction of the seat will be referred to as a Z-axis direction. Furthermore, the left-and-right direction of the seat, that is, the direction perpendicular to both the X-axis direction and the Z-axis direction will be referred to as a Y-axis direction. Along the X-axis direction, the front side of the seat will be referred to as a positive side, and the rear side of the seat will be referred to as a negative side. Along the Y-axis direction, the left side of the seat (the lower right side in FIG. 1) will be referred to as a positive side, and the opposite side will be referred to as a negative side. The “right side” here means the right side of a person seated on the seat facing in the traveling direction of the vehicle, which is the negative direction along the Y axis. The “left side” here means the left side of a person seated on the seat facing in the traveling direction of the vehicle, which is the positive direction along the Y axis. Along the Z-axis direction, the upward side of the seat will be referred to as a positive side, and the downward side of the seat will be referred to as a negative side. The same holds true for FIG. 2 and the subsequent drawings.

In the following, embodiments will be specifically described with reference to the drawings.

### Embodiment 1

### <Configuration: Seat 1>

First, a configuration of seat 1 including vehicle seat air conditioning device 3 will be described with reference to FIGS. 1 to 4.

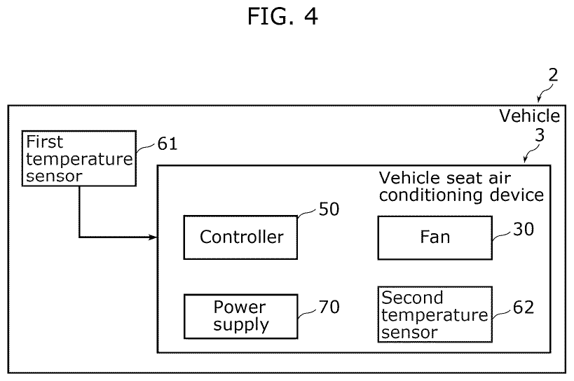

FIG. 1 is a perspective view illustrating an appearance of seat 1 provided with vehicle seat air conditioning device 3 according to Embodiment 1. The arrow indicated by an alternate long and short dash line in FIG. 1 illustrates a flow of air. FIG. 2 is a cross-sectional view of seat 1 provided with vehicle seat air conditioning device 3 taken along the line II-II in FIG. 1. FIG. 3 is a top view of seat 1 illustrating a blowing direction of air. FIG. 4 is a block diagram illustrating vehicle seat air conditioning device 3 according to Embodiment 1.

As illustrated in FIGS. 1 to 4, seat 1 provided in vehicle 2 or the like can cool a person seated on seat 1 by blowing air to the upper body of the person. Specifically, seat 1 can cool the body of the person seated on seat 1 by blowing air to at least one of the head, the neck, the shoulders, the back, and the like of the person from outlet 14 disposed at a corresponding position. Such seat 1 includes seat cushion 10 on which the person is seated, seat back 13, headrest 15, vehicle seat air conditioning device 3, and power supply 70.

### [Seat Cushion 10]

Seat cushion 10 is a seating part that supports the hip, the thighs, and the like of the person seated on seat 1. Seat cushion 10 has first seat pad 11a that corresponds to a cushion material and first seat cover 11b that covers first seat pad 11a.

First seat pad 11a is formed of polyurethane foam, for example, and forms the seat cushion main body. First seat pad 11a is thick and has an approximately rectangular plate-like shape and is disposed in an orientation substantially parallel to an X-Y plane. First seat pad 11a supports the hip, the thighs, and the like of the person seated on the seat.

First seat cover 11b is a cover that covers first seat pad 11a. First seat cover 11b is a leather cover or a fabric cover, for example.

### [Seat Back 13]

Seat back 13 is a backrest that supports the shoulders, the back, and the waist of the person seated on seat 1. Seat back 13 is longer in the Z-axis direction and is disposed to stand on seat cushion 10.

Seat back 13 includes second seat pad 13a that corresponds to a cushion material and second seat cover 13b that covers second seat pad 13a. Second seat pad 13a is formed of polyurethane foam, for example, and is disposed in an orientation that allows rotation about the Y axis. Second seat pad 13a supports the shoulders, the back, the waist, and the like of the person seated on the seat. Second seat cover 13b is a cover that covers second seat pad 13a. Second seat cover 13b is a leather cover or a fabric cover, for example.

Air duct 20 for guiding intake air to outlet 14 is provided in seat back 13. Air duct 20 is connected to an air conditioner of vehicle 2 via a duct, for example. In this case, cold air blown by the air conditioner directly flows into air duct 20. Therefore, the cold air blown by the air conditioner flows through air duct 20. Air duct 20 is an example of a flow path. Note that the air conditioner may be an air conditioning device for conditioning air inside the vehicle or may be a conditioned air generating device dedicated for seat 1.

Air duct 20 is provided with fan 30 and wind direction adjuster 40 disposed on the side toward outlet 14. Therefore, in seat back 13, air driven into air duct 20 by fan 30 reaches wind direction adjuster 40 and is blown out from outlet 14.

Outlet 14 blows out, from the surface of seat back 13, air sent by fan 30 and guided in air duct 20 formed in seat back 13.

A plurality of outlets 14 are formed on a surface of seat back 13. The surface of seat back 13 means a surface on the side of the person seated on seat 1. In this embodiment, as illustrate in FIG. 3, outlets 14 are formed on the right side and the left side of the person seated on seat 1 in such a manner that outlets 14 face the head and the neck of the person. Specifically, outlets 14 are disposed on seat back 13 in such a manner that the inward angle of the blowing direction of air toward the person with respect to the fore-and-aft direction (X-axis direction) of vehicle 2 in a top view of seat 1 falls within a range of 0° to 90° and the angle of elevation of air, that is, the angle of the upward blowing direction of air with respect to the left-and-right direction (Y-axis direction) of vehicle 2 falls within a range of 0° to 90°. Note that a plurality of outlets 14 may be distributed between the right shoulder and the left shoulder of the person seated on seat 1, for example.

Outlet 14 is formed toward headrest 15 on seat back 13. That is, one or more outlets 14 are formed on seat back 13 at positions corresponding to one or more of the head, the neck, the shoulders, and the back of the person. Outlets 14 may be disposed at positions where the shoulders and the like of the person do not interfere with outlets 14. As a result, air blown out from outlets 14 grazes along the head and the neck of the person, especially along the cheeks of the person.

### [Headrest 15]

Headrest 15 is a support for the head of the person seated on seat 1. Headrest 15 is fixed at a positive-side end of seat back 13 along the Z axis.

Note that outlet 14 may be formed on headrest 15. That is, a part of air duct 20 may be provided in headrest 15.

### [Vehicle Seat Air Conditioning Device 3]

Vehicle seat air conditioning device 3 is an air conditioning device that is used in seat 1 of a vehicle having seat back 13 and seat cushion 10 and can blow air to a person seated on seat 1 from the rear of the person. Vehicle seat air conditioning device 3 achieves air blowing by blowing intake air to the person.

Therefore, when air at a temperature lower than room temperature flows in air duct 20, the air is referred to as cold air, and when air at a temperature higher than room temperature flows in air duct 20, the air is referred to as warm air.

Vehicle seat air conditioning device 3 includes fan 30, air duct 20, wind direction adjuster 40, controller 50, and second temperature sensor 62.

Fan 30 is disposed on air duct 20. Therefore, fan 30 can make air flow into air duct 20 and make the influent air be blown out from outlet 14 formed on seat back 13. Specifically, fan 30 is electrically connected to controller 50 and is driven and controlled by controller 50 to guide the influent air into air duct 20 and blow out the air from outlet 14.

Fan 30 is built in seat 1. For example, FIG. 1 showing this embodiment illustrates a case where fan 30 is disposed inside seat cushion 10. Fan 30 may be built in seat back 13. That is, the position of fan 30 is not particularly limited as far as fan 30 is built in seat 1.

Air duct 20 is built in seat 1. Specifically, air duct 20 extends from outside seat 1 to fan 30 and then from fan 30 to outlet 14. Since outlet 14 is disposed in the vicinity of headrest 15, air duct 20 extends to the vicinity of headrest 15.

In this embodiment, air duct 20 is a flow path from seat cushion 10 to outlet 14 on seat back 13. Therefore, air duct 20 can guide air having flown thereinto by the action of fan 30 to outlet 14. Air duct 20 may be a simple through-hole formed on seat 1 or may be formed by a ventilation duct, for example.

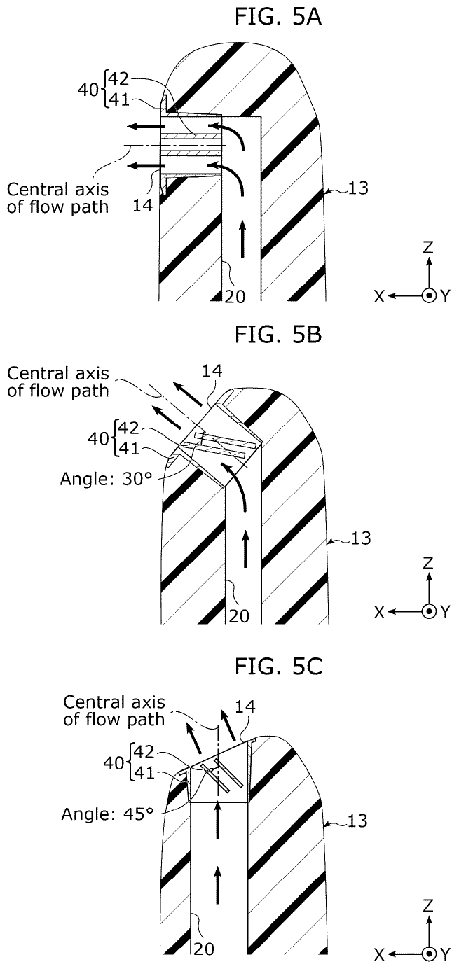

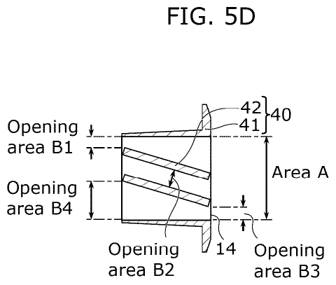

Next, a configuration of wind direction adjuster 40 will be described with reference to FIG. 5A to FIG. 5C.

FIG. 5A is a cross-sectional view illustrating a case where plate 42 of wind direction adjuster 40 is in an orientation approximately parallel to a central axis of the flow path in housing 41. FIG. 5B is a cross-sectional view illustrating a case where plate 42 of wind direction adjuster 40 is in an orientation tilted 30° in the fore-and-aft direction with respect to the central axis of the flow path in housing 41. FIG. 5C is a cross-sectional view illustrating a case where plate 42 of wind direction adjuster 40 is in an orientation tilted 45° in the fore-and-aft direction with respect to the central axis of the flow path in housing 41. In FIG. 5A to FIG. 5C, illustration of headrest 15, second seat cover 13b, and the like is omitted. Arrows in FIG. 5A to FIG. 5C indicate a flow of air. The directions of the arrows in FIG. 5A to FIG. 5C are merely examples, and the flow of air is not necessarily produced in the directions of the arrows. Therefore, the directions of the arrows illustrated in FIG. 5A to FIG. 5C do not necessarily indicate the blowing direction of air. FIG. 5A to FIG. 5C illustrate cases where wind direction adjuster 40 is disposed in seat back 13. Note that the arrangement of wind direction adjuster 40 illustrated in FIG. 5A to FIG. 5C is merely an example, and the arrangement of wind direction adjuster 40 is not limited to that illustrated in FIG. 5A to FIG. 5C.

Wind direction adjuster 40 is provided in outlet 14. In this embodiment, as illustrated in FIG. 3, outlets 14 and wind direction adjusters 40 are disposed in seat back 13 on the right side and the left side of the person seated on seat 1. Note that wind direction adjuster 40 may be covered with second seat cover 13b with a through-hole formed therein. In that case, air is blown out through the through-hole.

As illustrated in FIG. 5A to FIG. 5C, in this embodiment, wind direction adjuster 40 forms outlet 14 in cooperation with air duct 20. Specifically, wind direction adjuster 40 includes housing 41 and one or more plates 42.

Housing 41 has a tubular shape and has openings at both ends. That is, air guided through air duct 20 flows into the opening at one end of housing 41 and then is blown out from the opening at the other end. Therefore, the inside of housing 41 forms a part of air duct 20, and the opening at the other end forms outlet 14.

Plate 42 is housed in housing 41. Plate 42 is disposed in housing 41 in an orientation approximately parallel to or tilted with respect to the central axis of the flow path in housing 41 in which the air to be blown out from outlet 14 flows (referred to simply as a central axis of a flow path, hereinafter). That is, plate 42 is disposed in housing 41 in an orientation approximately parallel to or tilted with respect to the central axis of the flow path, depending on the orientation in which wind direction adjuster 40 is disposed. Here, the tilted orientation means that an upper end of plate 42 is tilted toward the surface of seat back 13 (the surface on the side of the person seated) compared with the state where plate 42 is parallel to the central axis of the flow path. In this case, the upper end of plate 42 is closer to the surface of seat back 13 so that air is blown to the person along plate 42.

With regard to the orientation of plate 42, for example, the angle of inclination of plate 42 with respect to the central axis of the flow path falls within a range of 0° to 45°. Here, the central axis of the flow path is a central axis of housing 41. The central axis of the flow path is approximately parallel to the direction of the flow path of air flowing in housing 41.

Furthermore, plate 42 is provided in housing 41 in such a manner that the angle of inclination with respect to the central axis of the flow path can be changed. Plate 42 is rotatably supported on a shaft in housing 41. The angle of inclination of plate 42 may be manually changed or automatically changed by an actuator or the like.

Plate 42 adjusts the direction of blowing of air blown out from outlet 14. That is, plate 42 can guide the air flowing in housing 41.

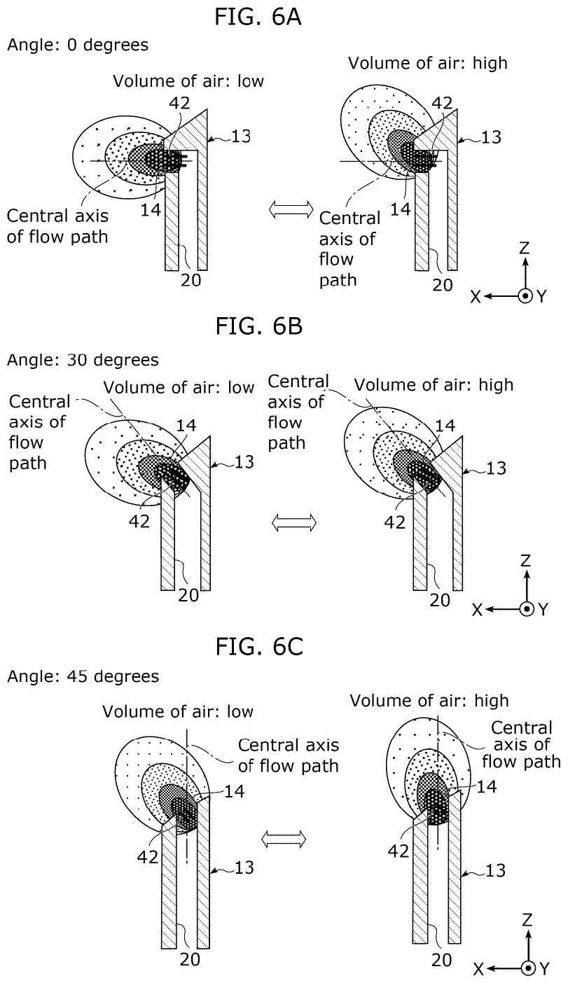

Here, a relationship between the orientation of plate 42 and the blowing direction of air will be described with reference to FIG. 6A to FIG. 6C.

FIG. 6A includes cross-sectional views illustrating a blowing direction of air when the volume of air is high and a blowing direction of air when the volume of air is low in the case where plate 42 of wind direction adjuster 40 is in an orientation approximately parallel to the central axis of the flow path in housing 41. FIG. 6B includes cross-sectional views illustrating a blowing direction of air when the volume of air is high and a blowing direction of air when the volume of air is low in the case where plate 42 of wind direction adjuster 40 is in an orientation tilted 30° with respect to the central axis of the flow path in housing 41. FIG. 6C includes cross-sectional views illustrating a blowing direction of air when the volume of air is high and a blowing direction of air when the volume of air is low in the case where plate 42 of wind direction adjuster 40 is in an orientation tilted 45° with respect to the central axis of the flow path in housing 41. In FIG. 6A to FIG. 6C, the denser the hatch dots, the higher the volume of air is.

As illustrated in FIG. 6A, when outlet 14 opens in a horizontal direction, and the central axis of the flow path is approximately parallel to the X-axis direction, plate 42 is disposed in housing 41 in an orientation approximately parallel to the central axis of the flow path. In this case, when the volume of air blown out from outlet 14 is low, the blowing direction of air is a direction along the central axis of the flow path. However, when the volume of air blown out from outlet 14 is high, the blowing direction of air is an upward direction with respect to the central axis of the flow path. Here, the “horizontal direction” indicating the direction of outlet 14 is not limited to the exact horizontal direction but means that outlet 14 substantially opens in the horizontal direction, that is, an error of the order of several percents is allowed.

In air duct 20 in FIG. 6A, a flow path extending in the Z-axis direction and a flow path in wind direction adjuster 40 extending in the X-axis direction, along which wind direction adjuster 40 is disposed, are formed. Note that the longer the flow path in wind direction adjuster 40 extending in the X-axis direction, the steadier the air flowing in the flow path is, and therefore, the more easily the direction of air blown out from outlet 14 can be adjusted by plate 42.

As illustrated in FIG. 6B and FIG. 6C, when outlet 14 opens in an upward direction, and the central axis of the flow path is tilted with respect to the X-axis direction, plate 42 is disposed in housing 41 in an orientation tilted with respect to the central axis of the flow path.

In the cases in FIG. 6B and FIG. 6C, when the volume of air blown out from outlet 14 is low, air is blown out along plate 42, and therefore, the blowing direction of air is a direction along the extension line of plate 42. However, when the volume of air blown out from outlet 14 is high, the blowing direction of air is a direction along the central axis of the flow path.

That is, although air is blown out from outlet 14 without being significantly affected by the tilt of plate 42 when the volume of air is high, air is blown out from outlet 14 along the tilt of plate 42 when the volume of air is low.

When the flow speed or turbulence of air passing through wind direction adjuster 40 is high, a trouble may occur in the air direction control with plate 42. In this case, when the volume of air blown out from outlet 14 changes from extremely low to high and then to low in a period of cooling down until the temperature adjustment by an air conditioning device inside the vehicle becomes stable, plate 42 may be designed so that the axis of the flow of air blown out from outlet 14 deviates from the person in an early stage of cooling down (in which the volume of air is extremely low). In a middle stage of cooling down (in which the volume of air is high), the speed of air is high, the turbulence is excessively intense, and the blowing direction of air does not coincide with the direction (orientation) of plate 42, so that the orientation and shape of outlet 14 may be determined so that the axis of the flow of air is directed to the person. In a late stage of cooling down and a stable period (in which the volume of air is low), the speed of air may be controlled by controller 50 controlling the rate of rotation of fan 30 so that the axis of the flow of air is generally directed along the orientation of plate 42.

Next, an opening ratio of outlet 14 of wind direction adjuster 40 will be described with reference to FIG. 5D. FIG. 5D is a cross-sectional view illustrating area A and opening areas B1, B2, B3, and B4 of wind direction adjuster 40.

In this embodiment, the opening ratio of outlet 14 may be prescribed to be 45% to 85%.

Specifically, the opening ratio of outlet 14 is on the order of 80% when plate 42 of wind direction adjuster 40 is in an orientation approximately parallel to the central axis of air duct 20 as illustrated in FIG. 5A, and is on the order of 50% when plate 42 is in an orientation tilted with respect to the central axis of air duct 20 as illustrated in FIG. 5B or FIG. 5C.

Considering the thickness of plate 42, it is probably difficult to increase the opening ratio of outlet 14 to be higher than 85%. Therefore, an upper limit of the opening ratio of outlet 14 is prescribed to be 85%. On the other hand, the lower the opening ratio of outlet 14, the higher the pressure loss of the air passing through wind direction adjuster 40 is, and therefore, it is considered that the volume of air blown from wind direction adjuster 40 decreases and noise occurs. Therefore, a lower limit of the opening ratio of outlet 14 is prescribed to be 45%.

The opening ratio of outlet 14 is expressed as opening ratio=(opening area B/area A)×100. Opening area B is expressed as opening area B=opening area B1+opening area B2+ . . . . FIG. 5D illustrates a case where two plates 42 are provided. Depending on the number of plates 42 provided, opening area B may be expressed as opening area B=opening area B1+opening area B2+opening area B3 as in this embodiment or may be expressed as opening area B=opening area B1+opening area B2.

Next, the size of wind direction adjuster 40 will be described.

Wind direction adjuster 40 has an inner diameter that depends on the size of the inner diameter of air duct 20. For example, in this embodiment, a maximum volume of air blown from one wind direction adjuster 40 is on the order of 3.5 m³/h, an equivalent diameter of outlet 14 is 21 mm, and an in-tube average air speed in wind direction adjuster 40 determined from the equivalent diameter of outlet 14 is 2.9 m/s.

Next, the flow of air blown from wind direction adjuster 40 will be described by using the Reynolds number Re.

It is generally known that when the Reynolds number Re of a fluid flowing in a tube is less than 2300, the flow is a laminar flow. It is also known that when the Reynolds number Re is between 2300 and 4000, there are both a turbulent flow of air and a laminar flow of air in housing 41. It is also known that when the Reynolds number Re is more than 4000, the flow is a turbulent flow.

In the case where the equivalent diameter is 21 mm, the Reynolds number Re is less than 1000 when the volume of air is extremely low. For example, in the case where the air speed is 0.4 m/s, the Reynolds number Re is determined to be 554. That is, when the volume of air is extremely low, the flow of air is a laminar flow, and the axis of the flow of air coincides with the orientation of plate 42.

When the volume of air is high, the Reynolds number Re is more than 4000. For example, when the air speed is 2.9 m/s, the Reynolds number Re is determined to be 4013. That is, when the volume of air is high, the flow of air is likely to be a turbulent flow, and the axis of the flow of air does not coincide with the orientation of plate 42.

When the volume of air is low, the Reynolds number Re is between 1200 and 3000. For example, when the air speed is 0.9 to 2.1 m/s, the Reynolds number Re is determined to be 1246 to 2976. When the Reynolds number Re is more than 2300, the air speed is 1.7 m/s. That is, when the volume of air is low, the axis of the flow of air generally coincides with the orientation of plate 42. More specifically, the difference in angle between the axis of the flow of air and plate 42 is smaller than when the volume of air is high.

Here, vehicle seat air conditioning device 3 illustrated in FIG. 4 will be described again.

Controller 50 controls fan 30. Specifically, controller 50 is a microcomputer that controls the output of fan 30 by turning on and off a current to be flown to fan 30 (or changing the duty cycle) or changing the current value.

Controller 50 controls the rate of rotation of fan 30 based on a first temperature, which is the temperature inside vehicle 2 detected by first temperature sensor 61 installed in vehicle 2, and a second temperature, which is the temperature of air blown out from outlet 14 detected by second temperature sensor 62. In the following, a case where vehicle seat air conditioning device 3 blows cold air will be described.

Specifically, when the first temperature is a first predetermined temperature or higher, controller 50 controls fan 30 so that the rate of rotation of fan 30 is a first rate of rotation. When the first temperature is the first predetermined temperature or higher, plate 42 may be disposed in housing 41 in an orientation more significantly tilted with respect to the central axis of the flow path than when the first temperature is less than the first predetermined temperature. When the first temperature is less than the first predetermined temperature, controller 50 controls fan 30 so that the rate of rotation of fan 30 is higher than the first rate of rotation. The first rate of rotation is the minimum rate of rotation in this embodiment.

When the first temperature is less than the first predetermined temperature, if value ΔT2 (differential temperature) obtained by subtracting second temperature Ta from first temperature T is a second predetermined temperature or higher, controller 50 controls fan 30 so that the rate of rotation of fan 30 is a second rate of rotation, which is greater than the first rate of rotation. If value ΔT2 obtained by subtracting second temperature Ta from first temperature T is less than the second predetermined temperature, controller 50 controls fan 30 so that the rate of rotation of fan 30 is a third rate of rotation, which is greater than the first rate of rotation and is less than the second rate of rotation. The second rate of rotation is the maximum rate of rotation in this embodiment.

Second temperature sensor 62 detects the temperature of air flowing in air duct 20. Second temperature sensor 62 needs to be disposed in air duct 20 and may be disposed in the vicinity of outlet 14 or in housing 41 of wind direction adjuster 40, for example. Second temperature sensor 62 outputs information indicating the second temperature to controller 50 as a detection result.

Although a case where vehicle seat air conditioning device 3 includes second temperature sensor 62 is illustrated in this embodiment, the present disclosure is not limited to this. For example, temperature information obtained by controller 50 from an air conditioner of vehicle 2 may be the second temperature. Controller 50 may also estimate the second temperature based on the operating time of the air conditioner of vehicle 2 or may estimate the second temperature based on a temperature from a thermistor installed in seat 1. That is, second temperature sensor 62 is not an essential component of vehicle seat air conditioning device 3.

### [Power Supply 70]

Power supply 70 is a power supply circuit that supplies electric power to fan 30 via controller 50 or the like. Here, power supply 70 is a direct-current power supply provided by a battery (not illustrated). Power supply 70 adjusts the current to be supplied to fan 30 under the control of controller 50.

### [First Temperature Sensor 61]

First temperature sensor 61 is installed in vehicle 2. First temperature sensor 61 is an in-car temperature sensor that detects the temperature inside vehicle 2. In this embodiment, first temperature sensor 61 detects the temperature of the inside of the vehicle, which is a space in which there is a person. For example, first temperature sensor 61 may be a temperature sensor previously provided in the air conditioner of vehicle 2. First temperature sensor 61 outputs information indicating the first temperature, which is the temperature inside the vehicle, to controller 50 as a detection result. Note that first temperature sensor 61 is not an essential component of seat 1 and need not be included in the components of seat 1.

First temperature sensor 61 may be provided in seat 1. In that case, vehicle seat air conditioning device 3 may be provided with first temperature sensor 61.

Although a case where vehicle 2 is provided with first temperature sensor 61 is illustrated in this embodiment, the present disclosure is not limited to this. For example, controller 50 may estimate the first temperature based on the operating time of the air conditioner of vehicle 2 or may estimate the first temperature based on the temperature from the thermistor installed in seat 1. That is, first temperature sensor 61 is not an essential component of vehicle 2.

### <Process Operations>

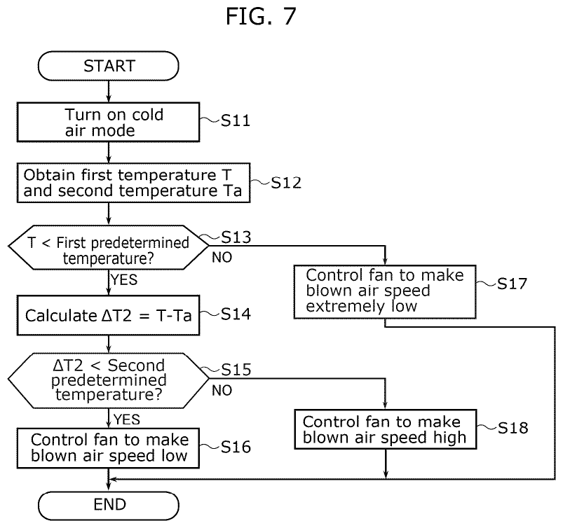

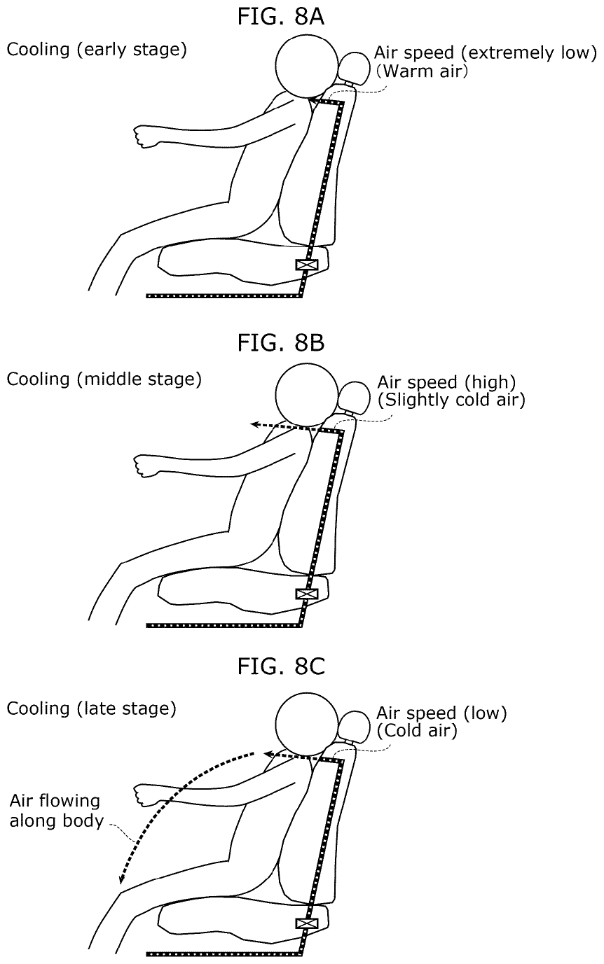

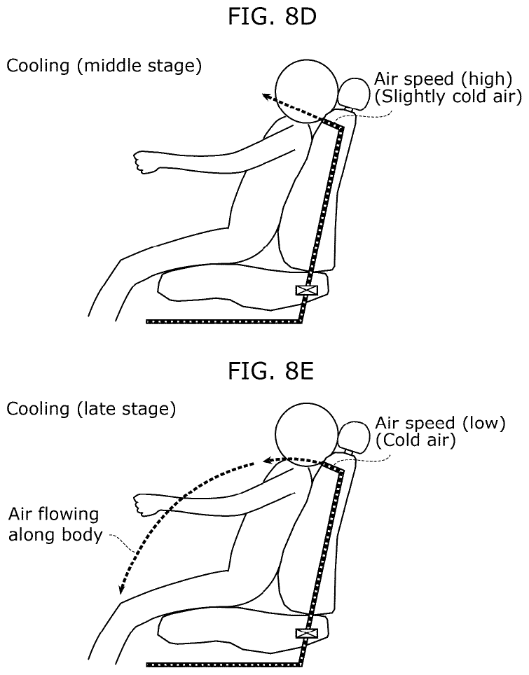

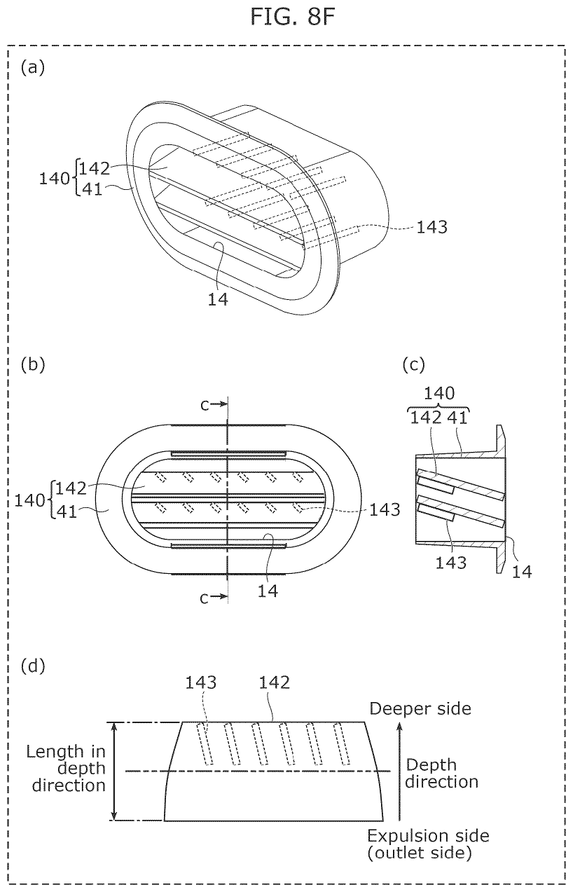

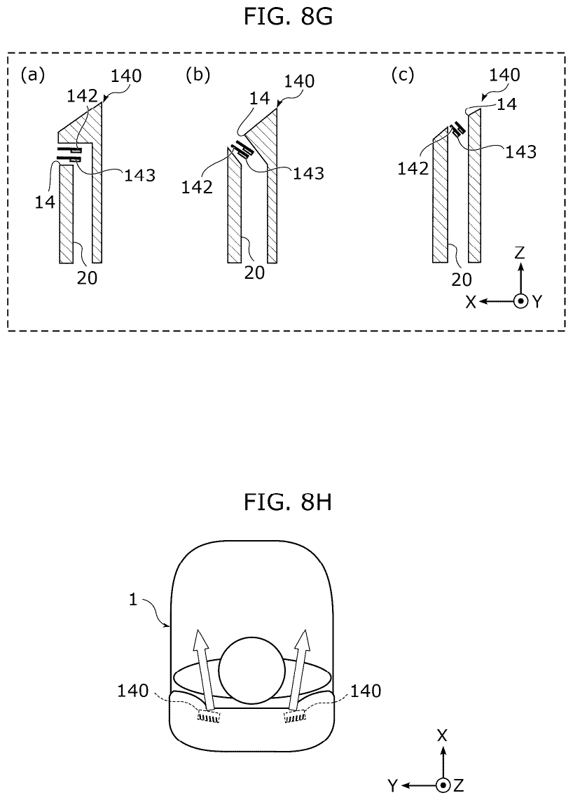

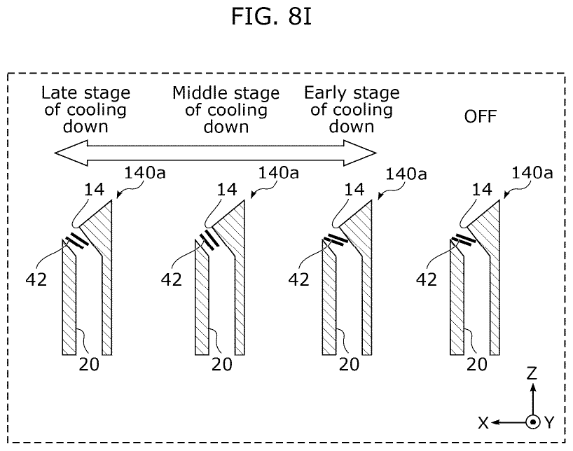

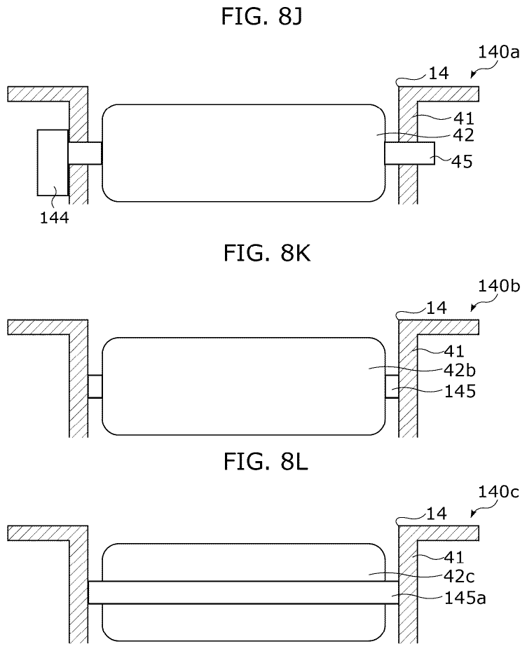

Next, process operations of vehicle seat air conditioning device 3 will be described with reference to FIG. 7 and FIG. 8A to FIG. 8C.

FIG. 7 is a flowchart illustrating a process of vehicle seat air conditioning device 3 according to Embodiment 1. FIG. 8A is a diagram illustrating a flow of air blown to the person when the volume of air blown out from outlet 14 is extremely low. FIG. 8B is a diagram illustrating a flow of air blown to the person when the volume of air blown out from outlet 14 is high. FIG. 8C is a diagram illustrating a flow of air blown to the person when the volume of air blown out from outlet 14 is low. In FIG. 8A to FIG. 8C, the flows of air are indicated by dashed-line arrows. The directions of the arrows in FIG. 8A to FIG. 8C are merely examples, and the flows of air are not necessarily limited to the directions of the arrows. Therefore, the directions of the arrows illustrated in FIG. 8A to FIG. 8C do not necessarily indicate blowing directions of air.

As illustrated in FIG. 7, controller 50 of vehicle seat air conditioning device 3 first turns on a cold air mode (S11). In this way, controller 50 starts controlling fan 30.

Controller 50 then obtains information indicating first temperature T, which is the temperature inside the vehicle detected by first temperature sensor 61, and information indicating second temperature Ta, which is the temperature of air blown out from outlet 14 detected by second temperature sensor 62 (S12). Second temperature Ta is the blowing temperature of air blown out from outlet 14. First temperature T is a vehicle atmosphere temperature, that is, the temperature inside the vehicle.

Controller 50 then determines whether first temperature T is less than a first predetermined temperature or not (S13). The first predetermined temperature is a temperature higher than room temperature, such as 36° C.

When it is determined that first temperature T is the first predetermined temperature or higher (NO in S13), controller 50 controls fan 30 to make the blown air speed from outlet 14 extremely low (S17). For example, when the outside air temperature is high or when the intensity of solar radiation is high, the temperature inside the vehicle is the first predetermined temperature or higher immediately after the person has gotten in vehicle 2. In that case, since the temperature inside the vehicle is high, the person seated on seat 1 may feel very hot. In such a case, the air blown from outlet 14 will be at a higher temperature than the body temperature of the person, so that the air speed should be lowered so that the air is not blown to the person. To this end, as illustrated in FIG. 8A, controller 50 sets the rate of rotation of fan 30 to a first rate of rotation (extremely low) so that the blown air speed from outlet 14 is extremely low. When the air speed is extremely low, only a slight volume of air is blown out from outlet 14, so that the air is blown out along plate 42 and is not blown to the person. As a result, the warm air is not blown to the person, so that the person is less likely to feel uncomfortable. Here, the blown air speed from outlet 14 described as extremely low here is 0.4 (m/s) or lower, for example.

Vehicle seat air conditioning device 3 then ends the process operations in FIG. 7.

When it is determined that first temperature T is less than the first predetermined temperature (YES in S13), controller 50 calculates differential temperature ΔT2 (S14).

Controller 50 then determines whether differential temperature ΔT2 is less than a second predetermined temperature or not (S15). Here, the second predetermined temperature is −3° C., for example.

When it is determined that differential temperature ΔT2 is the second predetermined temperature or higher (NO in S15), controller 50 controls fan 30 to make the blown air speed from outlet 14 high (S18). For example, when the outside air temperature is high or when the intensity of solar radiation is high, the temperature inside the vehicle (the first temperature) may still be a target temperature or higher even after the inside of vehicle 2 has begun being cooled by the air conditioner of vehicle 2. In that case, since the temperature inside the vehicle is still high, the person seated on seat 1 may feel hot. In such a case, slightly cooled air will be blown from outlet 14, so that the air speed should be increased so that the head, the neck, the shoulders, the back, and other parts of the person are actively cooled to reduce the surface temperature of the person seated on seat 1. To this end, as illustrated in FIG. 8B, controller 50 controls the rate of rotation of fan 30 to be high so that the blown air speed from outlet 14 is high. When the volume of air is high, air is blown out from outlet 14 without being significantly affected by the tilt of plate 42, compared with when the volume of air is low. Therefore, the air blown out from outlet 14 is blown to one or more of the head, the neck, the shoulders, and the back of the person. As a result, the body of the person can be partially cooled. Here, the blown air speed from outlet 14 described as high here is 2.0 (m/s) or higher, for example.

Vehicle seat air conditioning device 3 then ends the process operations in FIG. 7.

When it is determined that differential temperature ΔT2 is less than the second predetermined temperature (YES in S15), controller 50 controls fan 30 to make the blown air speed from outlet 14 low (S16). For example, when the outside air temperature is high or when the intensity of solar radiation is high, the inside of vehicle 2 may be effectively cooled by the air conditioner of vehicle 2, and the temperature inside the vehicle (the first temperature) may be close to the target temperature. In that case, since the temperature inside the vehicle is appropriate, the person seated on seat 1 may feel comfortable. In such a case, the air speed should be lowered to avoid excessively cooling the body of the person. To this end, as illustrated in FIG. 8C, controller 50 controls the rate of rotation of fan 30 to be low so that the blown air speed from outlet 14 is low. When the volume of air is low, air blown out from outlet 14 is affected by the tilt of plate 42. In that case, air is blown out from outlet 14 along plate 42 of wind direction adjuster 40. In addition, since the air is cooled, the air tends to flow vertically downward because of the specific gravity. In this way, due to the guiding of the air by plate 42 and the specific gravity of the air, an air flow along the body of the person can be produced to embrace the body of the person. As a result, the entire body of the person can be cooled without excessively cooling the body of the person. Here, the blown air speed from outlet 14 described as low here is higher than 0.4 (m/s) and less than 2.0 (m/s), for example.

Note that the dashed-line arrows indicating flows of air in FIG. 8B and FIG. 8C described above are merely examples, and the flows of air are not limited to those in FIG. 8B and FIG. 8C. For example, flows of air in FIG. 8D and FIG. 8E are also possible. FIG. 8D is another diagram illustrating a flow of air blown to the person when the volume of air blown out from outlet 14 is high. FIG. 8E is another diagram illustrating a flow of air blown to the person when the volume of air blown out from outlet 14 is low.

As illustrated in FIG. 8D, when the volume of air blown out from outlet 14 is high, the air blown out from outlet 14 may be blown to the head (such as the cheeks) of the person. As illustrated in FIG. 8E, when the volume of air blown out from outlet 14 is low, the air blown out from outlet 14 may flow in an arc along the body of the person to embrace the body of the person because of the specific gravity of the air.

Vehicle seat air conditioning device 3 then ends the process operations in FIG. 7.

As described above, vehicle seat air conditioning device 3 can provide an optimum air blow pattern by controlling the air speed in accordance with the temperature of the air blown out from outlet 14.

### Advantageous Effects

Next, advantageous effects of vehicle seat air conditioning device 3 according to this embodiment will be described.

As described above, vehicle seat air conditioning device 3 is vehicle seat air conditioning device 3 for use in seat 1 including seat back 13 and seat cushion 10, and vehicle seat air conditioning device 3 includes fan 30 built in seat 1, controller 50 that controls fan 30, and outlet 14 that blows out, from a surface of seat back 13, air sent by fan 30 and guided through a flow path formed in seat back 13. Outlet 14 is provided with wind direction adjuster 40 including one or more plates 42 that adjust a blowing direction of air blown out from outlet 14. One or more plates 42 are disposed in an orientation approximately parallel to or tilted with respect to a central axis of the flow path along which air to be blown out from outlet 14 flows. Controller 50 controls the rate of rotation of fan 30 based on a first temperature which is the temperature inside the vehicle, and a second temperature which is the temperature of air blown out from outlet 14.

According to this, wind direction adjuster 40 and outlet 14 of vehicle seat air conditioning device 3 are provided in seat 1, and fan 30 is built in seat 1. That is, all the components that produce an air flow that embraces the person seated on seat 1 are provided in seat 1, and therefore, vehicle seat air conditioning device 3 has a simple configuration.

Furthermore, the blowing direction of air blown out from outlet 14 can be adjusted by controlling the rate of rotation of fan 30, without using an actuator that drives plates 42 of wind direction adjuster 40. Therefore, compared with a conventional vehicle seat air conditioning device with an actuator installed in the seat, vehicle seat air conditioning device 3 according to this embodiment has a simple structure and can be manufactured at low cost.

Therefore, with vehicle seat air conditioning device 3, the structure can be prevented from being complicated, and the manufacturing cost can be prevented from being increased.

Furthermore, the conventional vehicle seat air conditioning device has only one pattern of air blowing in the period of cooling down until the temperature adjustment by the air conditioning device becomes stable, and an optimum blowing cannot be achieved in each of the early stage, the middle stage and the late stage of cooling down. However, according to this embodiment, an optimum blowing pattern can be achieved in each stage until the temperature adjustment by the air conditioning device becomes stable.

In vehicle seat air conditioning device 3 according to this embodiment, outlet 14 opens to face in a vertically upward direction. Plates 42 are disposed in an orientation tilted with respect to the central axis of the flow path.

According to this, when outlet 14 is disposed near the headrest, for example, outlet 14 opens to face in the vertically upward direction. In this case, if plates 42 are disposed in a tilted orientation, the blowing direction of air blown out from outlet 14 can be adjusted by controlling the rate of rotation of fan 30. That is, by adjusting the volume of air blown out from outlet 14, air can be partially blown to the body of the person or can be blown along the body of the person.

In vehicle seat air conditioning device 3 according to this embodiment, outlet 14 opens to face in a horizontal direction. Plates 42 are disposed in an orientation approximately parallel to the central axis of the flow path.

According to this, when outlet 14 is disposed to be opposed to the shoulders, the back, and the like of the person seated on seat 1, for example, outlet 14 opens to face in the horizontal direction. In this case, if plates 42 are disposed in a horizontal orientation, the blowing direction of air blown out from outlet 14 can be adjusted by controlling the rate of rotation of fan 30. That is, by adjusting the volume of air blown out from outlet 14, air can be partially blown to the body of the person or can be blown along the body of the person.

In vehicle seat air conditioning device 3 according to this embodiment, when the first temperature is a first predetermined temperature or higher, controller 50 sets the rate of rotation of fan 30 to a first rate of rotation and when the first temperature is less than the first predetermined temperature, controller 50 sets the rate of rotation of fan 30 to a rate of rotation greater than the first rate of rotation.

According to this, when the first temperature is the first predetermined temperature or higher, for example, the person seated on seat 1 may feel very hot, so that the rate of rotation of fan 30 is set to the first rate of rotation. Even if the air blown from outlet 14 is at the first predetermined temperature or higher, if the first rate of rotation is set to be the minimum rate of rotation, the air speed from outlet 14 is extremely low, so that the air can be prevented from being blown to the person. In this way, warm air is not blown to the person, so that the person is less likely to feel uncomfortable.

Furthermore, when the first temperature is less than the first predetermined temperature, the person seated on seat 1 may feel hot or comfortable, so that the rate of rotation of fan 30 is set to a rate of rotation greater than the first rate of rotation. In this case, cooled air is blown from outlet 14, so that the body of the person can be cooled.

In a case where the first temperature is less than the first predetermined temperature, when a value (differential temperature) ΔT2 obtained by subtracting second temperature Ta from first temperature T is a second predetermined temperature or higher, controller 50 of vehicle seat air conditioning device 3 according to this embodiment causes fan 30 to set the rate of rotation of fan 30 to a second rate of rotation greater than the first rate of rotation, and when the value ΔT2 obtained by subtracting second temperature Ta from first temperature T is less than the second predetermined temperature, controller 50 causes fan 30 to set the rate of rotation of fan 30 to a third rate of rotation greater than the first rate of rotation and less than the second rate of rotation.

According to this, when differential temperature ΔT2 is the second predetermined temperature or higher, the temperature inside the vehicle may be the target temperature or higher although the inside of vehicle 2 has begun being cooled by the air conditioner of vehicle 2. In that case, since the temperature inside the vehicle is still high, the person seated on seat 1 may feel hot. Therefore, controller 50 sets the rate of rotation of fan 30 to the second rate of rotation so that the speed of air blown from outlet 14 is high. As a result, the body of the person can be partially cooled.

When value ΔT2 obtained by subtracting second temperature Ta from first temperature T is less than the second predetermined temperature, the inside of vehicle 2 may be effectively cooled by an air conditioner of vehicle 2, and the temperature inside the vehicle (the first temperature) may be close to the target temperature. In that case, the temperature inside the vehicle is appropriate, so that the person seated on seat 1 may feel comfortable. Therefore, to avoid excessively cooling the body of the person, controller 50 sets the rate of rotation of fan 30 to the third rate of rotation so that the blown air speed from outlet 14 is low. As a result, the entire body of the person can be cooled without excessively cooling the body of the person.

### Variation 1 of Embodiment 1

A vehicle seat air conditioning device according to this variation differs from the vehicle seat air conditioning device according to Embodiment 1 in that plate 142 of wind direction adjuster 140 has protrusion 143. In other respects, this variation is the same as Embodiment 1. The same components or features will be denoted by the same reference numerals and will not be described in detail.

Wind direction adjuster 140 of the vehicle seat air conditioning device will be described with reference to FIG. 8F to FIG. 8H. FIG. 8F is a diagram illustrating wind direction adjuster 140 according to Variation 1 of Embodiment 1. FIG. 8F includes (a) of FIG. 8F illustrating the whole of wind direction adjuster 140, (b) of FIG. 8F illustrating a front of wind direction adjuster 140, (c) of FIG. 8F illustrating a cross section of wind direction adjuster 140 taken along the line c-c in (b) of FIG. 8F, and (d) of FIG. 8F illustrating plates 142 of wind direction adjuster 140. FIG. 8G is a diagram illustrating orientations of plates 142 of wind direction adjuster 140 according to Variation 1 of Embodiment 1. In FIG. 8G, illustration of a housing of wind direction adjuster 140 is omitted. FIG. 8G includes (a) of FIG. 8G illustrating a case where plates 142 are in an orientation approximately parallel to the X-axis direction, (b) and (c) of FIG. 8G illustrating cases where plates 142 are in an orientation tilted with respect to the X-axis direction. FIG. 8H is a top view of seat 1 illustrating a blowing direction of air when an air conditioner starts a cooling operation. FIG. 8H illustrates a case where the volume of air blown from outlets 14 is extremely low when the cold air mode of vehicle seat air conditioning device 3 is turned on.

As illustrated in (a) to (c) of FIG. 8F, protrusion 143 according to this variation is disposed on one surface of plate 142. A plurality of protrusions 143 are disposed on one surface of plate 142 side by side in a direction perpendicular to a depth direction of plate 142.

Specifically, when wind direction adjuster 140 is disposed in air duct 20 in such a manner that the inner surfaces of the housing of wind direction adjuster 140 are in an orientation along the X-axis direction as illustrated in (a) of FIG. 8G, protrusions 143 are disposed on the surface of plate 142 on the negative side along the Z axis.

When wind direction adjuster 140 is disposed in air duct 20 in such a manner that the inner surfaces of the housing of wind direction adjuster 140 are in an orientation tilted with respect to the Z-axis direction as illustrated in (b) of FIG. 8G, protrusions 143 are disposed on the surface of plate 142 on the negative side along the Z axis.

When wind direction adjuster 140 is disposed in air duct 20 in such a manner that the inner surfaces of the housing of wind direction adjuster 140 are in an orientation along the Z-axis direction as illustrated in (c) of FIG. 8G, protrusions 143 are disposed on the surface of plate 142 on the negative side along the Z axis. In this way, protrusions 143 are disposed on the surface of plate 142 opposed to the direction of the flow of air at the inlet of wind direction adjuster 140 or, in other words, the surface of plate 142 opposed to the direction of the flow of air in air duct 20 immediately before wind direction adjuster 140.

Protrusion 143 is an elongated projection extending in the depth direction of plate 142. As illustrated in (d) of FIG. 8F, protrusion 143 extends in an orientation tilted with respect to the depth direction. Note that the direction in which protrusion 143 extends is not limited to the direction exactly parallel to the depth direction. Protrusion 143 can guide air when the volume of air blown out from outlet 14 is extremely low.

In wind direction adjuster 140 according to this variation, as with the wind direction adjuster in FIG. 5D, for example, opening area B1 on the upper side of the wind direction adjuster is set to be smaller than opening area B4 on the lower side of the wind direction adjuster. Therefore, as illustrated in (a) to (c) of FIG. 8F, protrusions 143 disposed on one surface of plate 142 (on the lower side in (a) to (c) of FIG. 8F, for example) can guide air when air passes in wind direction adjuster 140. In this way, adequate straightening effect can be achieved.

As illustrated in (d) of FIG. 8F, protrusions 143 are disposed deeper in the depth direction of plate 142 than the midpoint of the length in the depth direction of plate 142. The depth direction of plate 142 can also be referred to as a flow path direction of air passing in wind direction adjuster 140, for example. In (d) of FIG. 8F, the midpoint of the length in the depth direction of plate 142 is indicated by an alternate long and two short dashes line. Since protrusions 143 guide air passing in wind direction adjuster 140, air can be blown in a wider range.

Note that protrusions 143 may extend from the expulsion side (outlet 14 side) to the depth of plate 142. Protrusions 143 may have a height that decreases from the deeper side toward the expulsion side.

For example, when the outside air temperature is high or when the intensity of solar radiation is high, the air blown out from the air conditioner at the start of cooling down can be uncomfortably hot, so that if such air is blown to a person from outlet 14, the person may feel uncomfortable. In view of this, according to this variation, when the cold air mode of vehicle seat air conditioning device 3 is turned on, the volume of air blown out from outlet 14 is extremely low. Furthermore, as illustrated in FIG. 8H, protrusions 143 are provided on plate 142 in such a manner that extension lines of the protrusions in the longitudinal direction thereof do not intersect with the person. That is, protrusions 143 of plate 142 are disposed on one surface of plate 142 in such a manner that protrusions 143 extend in the depth direction of plate 142 along the central axis of the flow path in housing 41 and the extension lines of protrusions 143 in the direction of extension thereof do not intersect with the person seated on seat 1. It can also be said that the direction of extension of protrusions 143 coincides with the axis of the flow of air. In this way, when the volume of air blown out from outlet 14 is extremely low, protrusions 143 can guide air passing in wind direction adjuster 140 so that the air is not directly blown to the person.

Then, when the inside of vehicle 2 begins to be cooled by the air conditioner of vehicle 2, and slightly cooled air is blown out from outlet 14, the volume of air is increased. Specifically, controller 50 controls the rate of rotation of fan 30 to be high so that the volume of air blown out from outlet 14 is high. When the volume of air is high, compared with when the volume of air is extremely low or low, air is blown out from outlet 14 without being significantly affected by the tilt of plate 142 or the tilt of protrusions 143. Therefore, the air blown out from outlet 14 is blown to one or more of the head, the neck, the shoulders, and the back of the person. As a result, the body of the person can be partially cooled.

Then, when the inside of vehicle 2 is effectively cooled by the air conditioner of vehicle 2, the temperature inside the vehicle is close to the target temperature, and cooled air is blown out from outlet 14, the volume of air is decreased. Specifically, controller 50 controls the rate of rotation of fan 30 to be low so that the volume of air blown out from outlet 14 is low. When the volume of air is low, air blown out from outlet 14 is affected to some extent by the tilt of plate 142 and the tilt of protrusions 143. Therefore, air is blown out from outlet 14 along plate 142 and protrusions 143 of wind direction adjuster 140. At this time, the air is cooled and therefore tends to flow vertically downward because of the specific gravity. In this way, air is guided by plate 142, and an air flow can be produced along the body of the person to embrace the body of the person due to the specific gravity of the air. As a result, the entire body of the person can be cooled without excessively cooling the body of the person.

In the vehicle seat air conditioning device according to this variation, plates 142 includes protrusion 143 on one surface of plate 142, and protrusion 143 can guide air.

According to this, when the volume of air blown out from outlet 14 is extremely low, protrusion 143 can guide air passing in wind direction adjuster 140.

In the vehicle seat air conditioning device according to this variation, protrusion 143 extends in the depth direction of plate 142 along the central axis and is disposed on one surface of plate 142 such that an extension line in a direction in which protrusion 143 extends does not intersect with the person seated on seat 1.

According to this, when the volume of air blown out from outlet 14 is extremely low, protrusion 143 can guide air passing in wind direction adjuster 140 so that the air is not directly blown to the person.

In the vehicle seat air conditioning device according to this variation, when plate 142 is divided into a front region and a back region at the midpoint of the length of plate 142 in a depth direction along the central axis, protrusion 143 is disposed in the back region.

According to this, protrusion 143 can start guiding air passing in wind direction adjuster 140 at a point where the air is blown to plate 142, and therefore, air can be blown in a wide range.

### Variation 2 of Embodiment 1

A vehicle seat air conditioning device according to this variation differs from the vehicle seat air conditioning device according to Embodiment 1 in that wind direction adjuster 140a has elastic holder 144. In other respects, this variation is the same as Embodiment 1. The same components or features will be denoted by the same reference numerals and will not be described in detail.

First, the volume of air blown out from outlet 14 of wind direction adjuster 140a and the orientation of plate 42 will be described with reference to FIG. 8I. FIG. 8I is a diagram illustrating a relationship between the volume of air and the orientation of plate 42. In FIG. 8I, illustration of a housing of wind direction adjuster 140a is omitted. Note that in FIG. 8I, the vehicle seat air conditioning device may be provided with a mechanism that controls the orientation of plate 42 in accordance with the volume of air.

Plate 42 is rotatably supported on a shaft in a housing and therefore can rotate in accordance with the volume of air. Specifically, as illustrated in FIG. 8I, when fan 30 is in the off state, no air is blown out from outlet 14 of wind direction adjuster 140a, and therefore, plate 42 is in a laid-down orientation.

Then, in the early stage of cooling down after fan 30 is turned on, the volume of air is extremely low, and the force of the air flow to make plate 42 rotate is smaller than the force to keep plate 42 still, so that plate 42 remains in the laid-down orientation. In this case, air is blown out from outlet 14 toward the positive side along the X axis, warm air can be prevented from being directly blown to the person. Therefore, the person can be prevented from feeling uncomfortable because of the warm air.

Then, in the middle stage of cooling down, the volume of air is high, so that a strong air flow produces a strong force to push plate 42 and make plate 42 rotate into an orientation parallel to the central axis of the flow path in housing 41. In this case, air is blown out from outlet 14 along the central axis of the flow path in housing 41, so that air is blown to one or more of the head, the neck, the shoulders, and the back of the person, and therefore, the body of the person can be partially cooled.

Then, in the late stage of cooling down, the volume of air is low, so that plate 42 is pushed by the air flow and made to rotate into an orientation between the laid-down orientation and the orientation parallel to the central axis of the flow path. Here, the force of the air flow to push plate 42 is smaller than when the volume of air passing through wind direction adjuster 140a is high and is greater than when the volume of air passing through wind direction adjuster 140a is extremely low. With regard to the angle of rotation of plate 42, there is a relationship: the angle of rotation when the volume of air passing through wind direction adjuster 140a is high>the angle of rotation when the volume of air passing through wind direction adjuster 140a is low>the angle of rotation when the volume of air passing through wind direction adjuster 140a is extremely low. In this case, since air is guided by plate 42, an air flow along the body of the person is produced to embrace the body of the person, so that the entire body of the person can be cooled without excessively cooling the body of the person.

Next, wind direction adjuster 140a of the vehicle seat air conditioning device will be described with reference to FIG. 8J. FIG. 8J is a diagram illustrating wind direction adjuster 140a according to Variation 2 of Embodiment 1.

Wind direction adjuster 140a according to this variation includes elastic holder 144 in addition to housing 41 and plate 42. Shaft 45 of plate 42 is rotatably supported on housing 41. Elastic holder 144 an elastic member and is formed by a spiral spring member or a spiral bimetal member, for example. Elastic holder 144 may also be a coil spring or a torsion bar, for example. That is, elastic holder 144 is not limited to a spiral elastic member.

Elastic holder 144 is coupled to shaft 45 of plate 42 and housing 41 and thus can maintain the orientation of plate 42 with respect to housing 41 in an initial position.

For example, when elastic holder 144 is a spring member, elastic holder 144 can automatically adjust the orientation of plate 42 in accordance with the volume of air blown out from outlet 14 of wind direction adjuster 140a.

For example, when elastic holder 144 is a bimetal, elastic holder 144 can automatically adjust the orientation of plate 42 with respect to housing 41 in accordance with the temperature of the air passing through outlet 14 of wind direction adjuster 140a.

In such a vehicle seat air conditioning device according to this variation, the orientation of plate 42 changes in accordance with the volume of air passing through wind direction adjuster 140a or the temperature of air that passes through wind direction adjuster 140a.

In this way, the orientation of plate 42 can automatically change in accordance with the volume of air passing through wind direction adjuster 140a. Therefore, in the early stage of cooling down (in which the volume of air is extremely low), the axis of the flow of air blown out from outlet 14 is directed not to intersect with the person, and warm air can be prevented from being directly blown to the person. In the middle stage of cooling down (in which the volume of air is high), the air speed is high, and the axis of the flow of air is directed to the person, so that the body of the person can be partially cooled. In the late stage of cooling down and the stable period (in which the volume of air is low), the axis of the flow of air is generally directed along the direction (orientation) of plate 42, so that a flow of air along the body of the person can be produced to embrace the body of the person, thereby cooling the entire body of the person.

### Variation 3 of Embodiment 1

A vehicle seat air conditioning device according to this variation differs from the vehicle seat air conditioning device according to Variation 1 of Embodiment 1 in that plate 42b of wind direction adjuster 140b is fixed to housing 41. In other respects, this variation is the same as Variation 1 of Embodiment 1. The same components or features will be denoted by the same reference numerals and will not be described in detail.

Wind direction adjuster 140b of the vehicle seat air conditioning device will be described with reference to FIG. 8K. FIG. 8K is a diagram illustrating wind direction adjuster 140b according to Variation 3 of Embodiment 1.

Wind direction adjuster 140b according to this variation includes connector 145 coupled to plate 42b in addition to housing 41 and plate 42b. Plate 42b of wind direction adjuster 140b is fixed to housing 41 by connector 145. Connector 145 cannot rotate with respect to housing 41. In this case, connector 145 may be integrally formed with housing 41 or may be firmly coupled (fixed) to housing 41. Connector 145 may be made of a resin material having flexibility. The resin material having flexibility is an elastomer resin, for example. As in the example in FIG. 8I described above, in this variation, connector 145 is twisted in accordance with the volume of air blown out from outlet 14 of wind direction adjuster 140b, so that the orientation of plate 42b can be automatically adjusted.

In such a vehicle seat air conditioning device according to this variation, again, the orientation of plate 42b changes in accordance with the volume of air that passes through wind direction adjuster 140b or the temperature of air that passes through wind direction adjuster 140b.

### Variation 4 of Embodiment 1

A vehicle seat air conditioning device according to this variation differs from the vehicle seat air conditioning device according to Variation 1 of Embodiment 1 in that plate 42c of wind direction adjuster 140c is fixed to housing 41. In other respects, this variation is the same as Variation 1 of Embodiment 1. The same components or features will be denoted by the same reference numerals and will not be described in detail.

Wind direction adjuster 140c of the vehicle seat air conditioning device will be described with reference to FIG. 8L. FIG. 8L is a diagram illustrating wind direction adjuster 140c according to Variation 4 of Embodiment 1.

Wind direction adjuster 140c according to this variation includes connector 145a coupled to plate 42c in addition to housing 41 and plate 42c. Plate 42c of wind direction adjuster 140c is fixed to housing 41 by connector 145a. Connector 145a cannot rotate with respect to housing 41. In this case, connector 145a may be integrally formed with housing 41 or may be firmly coupled (fixed) to housing 41. Plate 42c may be made of a resin material having flexibility. The resin material having flexibility is an elastomer resin, for example. As in the example in FIG. 8I described above, in this variation, plate 42c is twisted in accordance with the volume of air blown out from outlet 14 of wind direction adjuster 140c, so that the orientation of plate 42c can be automatically adjusted.

In such a vehicle seat air conditioning device according to this variation, again, the orientation of plate 42c changes in accordance with the volume of air passing through wind direction adjuster 140c or the temperature of air that passes through wind direction adjuster 140c.

### Embodiment 2

A vehicle seat air conditioning device according to this embodiment differs from the vehicle seat air conditioning device according to Embodiment 1 in that the blown air speed from outlet 14 is set in accordance with a skin temperature of a person. In other respects, this embodiment is the same as Embodiment 1. The same components or features will be denoted by the same reference numerals and will not be described in detail.

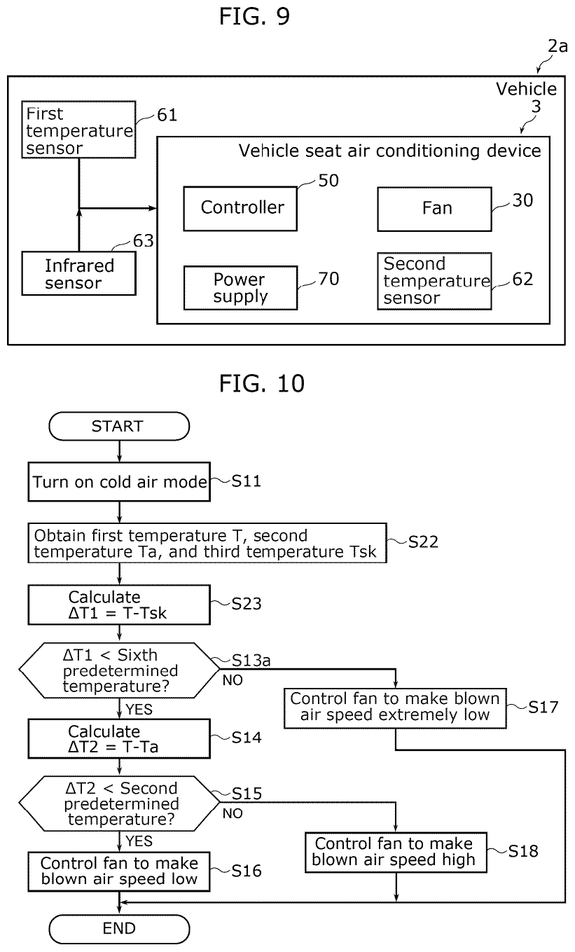

A configuration of seat 1 including vehicle seat air conditioning device 3 according to this embodiment will be described with reference to FIG. 9.

FIG. 9 is a block diagram illustrating vehicle seat air conditioning device 3 according to Embodiment 2.

According to this embodiment, as illustrated in FIG. 9, vehicle 2a is provided with infrared sensor 63. Note that infrared sensor 63 may be included in the components of seat 1.

Infrared sensor 63 is disposed on a dashboard or the like and detects a skin temperature, which is a surface temperature, of the person seated on seat 1. Infrared sensor 63 detects third temperature Tsk, which is the skin temperature of the head of the person seated on seat 1, for example. Infrared sensor 63 outputs information indicating third temperature Tsk to controller 50 as a detection result.

When value (differential temperature) ΔT1 obtained by subtracting third temperature Tsk from first temperature T is a sixth predetermined temperature or higher, controller 50 causes fan 30 to set the rate of rotation of fan 30 to a first rate of rotation.

When value ΔT1 obtained by subtracting third temperature Tsk from first temperature T is less than the sixth predetermined temperature, controller 50 causes fan 30 to set the rate of rotation of fan 30 to a rate of rotation greater than the first rate of rotation.

Specifically, in the case where value ΔT1 obtained by subtracting third temperature Tsk from first temperature T is less than the sixth predetermined temperature, when value (differential temperature) ΔT2 obtained by subtracting second temperature Ta from first temperature T is a second predetermined temperature or higher, controller 50 causes fan 30 to set the rate of rotation of fan 30 to a second rate of rotation greater than the first rate of rotation.

In the case where value ΔT1 obtained by subtracting third temperature Tsk from first temperature T is less than the sixth predetermined temperature, when value ΔT2 obtained by subtracting second temperature Ta from first temperature T is less than the second predetermined temperature, controller 50 causes fan 30 to set the rate of rotation of fan 30 to a third rate of rotation greater than the first rate of rotation and less than the second rate of rotation.

### <Process Operations>

Next, process operations of vehicle seat air conditioning device 3 will be described with reference to FIG. 10.

FIG. 10 is a flowchart illustrating a process of vehicle seat air conditioning device 3 according to Embodiment 2.

As illustrated in FIG. 10, controller 50 of vehicle seat air conditioning device 3 first turns on a cold air mode (S11). In this way, controller 50 starts controlling fan 30.

Controller 50 then obtains information indicating first temperature T, which is the temperature inside the vehicle detected by first temperature sensor 61, information indicating second temperature Ta, which is the temperature of air blown out from outlet 14 detected by second temperature sensor 62, and information indicating third temperature Tsk, which is the skin temperature of the person detected by infrared sensor 63 (S22).

Controller 50 then calculates differential temperature ΔT1 (S23).

Controller 50 then determines whether differential temperature ΔT1 is less than a sixth predetermined temperature or not (S13a). The sixth predetermined temperature is 0° C., for example.

When it is determined that differential temperature ΔT1 is the sixth predetermined temperature or higher (NO in S13a), controller 50 sets the rate of rotation of fan 30 to the first rate of rotation so that the blown air speed from outlet 14 is extremely low (S17).

Vehicle seat air conditioning device 3 then ends the process operations in FIG. 10.

When it is determined that differential temperature ΔT1 is less than the sixth predetermined temperature (YES in S13a), controller 50 calculates differential temperature ΔT2 (S14).

Controller 50 then determines whether differential temperature ΔT2 is less than a second predetermined temperature or not (S15).

When it is determined that differential temperature ΔT2 is the second predetermined temperature or higher (NO in S15), controller 50 sets the rate of rotation of fan 30 to a second rate of rotation so that the blown air speed from outlet 14 is high (S18).

Vehicle seat air conditioning device 3 then ends the process operations in FIG. 10.

When it is determined that differential temperature ΔT2 is less than the second predetermined temperature (YES in S15), controller 50 sets the rate of rotation of fan 30 to a third rate of rotation so that the blown air speed from outlet 14 is low (S16).

Vehicle seat air conditioning device 3 then ends the process operations in FIG. 10.

### Advantageous Effects

Next, advantageous effects of vehicle seat air conditioning device 3 according to this embodiment will be described.

The conventional vehicle seat air conditioning device includes an actuator that selectively switches an air blower between a first blowing state and a second blowing state and therefore has a problem that the structure is complicated and the manufacturing cost is high.

In view of this, with vehicle seat air conditioning device 3 according to this embodiment, as described above, when value (differential temperature) ΔT1 obtained by subtracting third temperature Tsk that is a skin temperature of the person from first temperature T is a sixth predetermined temperature or higher, controller 50 causes fan 30 to set the rate of rotation of fan 30 to a first rate of rotation, and when value ΔT1 obtained by subtracting third temperature Tsk from first temperature T is less than the sixth predetermined temperature, controller 50 causes fan 30 to set the rate of rotation of fan 30 to a rate of rotation greater than the first rate of rotation.

According to this, the temperature of the air blown from outlet 14 is higher than the skin temperature of the person, so that the person seated on seat 1 inside the vehicle may feel very hot. In that case, the rate of rotation of fan 30 is set to the first rate of rotation. Even if the air blown from outlet 14 is at a temperature higher than the skin temperature of the person, if the first rate of rotation is set to be the minimum rate of rotation, the air speed from outlet 14 is extremely low, so that the air can be prevented from being blown to the person. In this way, warm air is not blown to the person, so that the person is less likely to feel uncomfortable.

Alternatively, the person seated on seat 1 may feel hot or comfortable, and in that case, the rate of rotation of fan 30 is set to a rate of rotation greater than the first rate of rotation. In this case, cooled air is blown from outlet 14, so that the body of the person can be cooled.

Furthermore, in the case where value ΔT1 obtained by subtracting third temperature Tsk, which is the skin temperature of the person, from first temperature T is less than the sixth predetermined temperature, when value (differential temperature) ΔT2 obtained by subtracting second temperature Ta from first temperature T is a second predetermined temperature or higher, controller 50 of vehicle seat air conditioning device 3 according to this embodiment causes fan 30 to set the rate of rotation of fan 30 to a second rate of rotation greater than the first rate of rotation, and when value ΔT2 obtained by subtracting second temperature Ta from first temperature T is less than the second predetermined temperature, controller 50 causes fan 30 to set the rate of rotation of fan 30 to a third rate of rotation greater than the first rate of rotation and less than the second rate of rotation. According to this, when differential temperature ΔT2 is the second predetermined temperature or higher, the person seated on seat 1 may feel hot although the temperature of the air blown from outlet 14 is less than the skin temperature of the person. Therefore, controller 50 sets the rate of rotation of fan 30 to the second rate of rotation so that the blown air speed from outlet 14 is high. As a result, the body of the person can be partially cooled.

When differential temperature ΔT2 is less than the second predetermined temperature, the inside of vehicle 2a may be effectively cooled by the air conditioner of vehicle 2a, and the temperature inside the vehicle (the first temperature) may be close to a target temperature. In that case, the temperature inside the vehicle is appropriate, so that the person seated on seat 1 may feel comfortable. Therefore, to avoid excessively cooling the body of the person, controller 50 sets the rate of rotation of fan 30 to the third rate of rotation so that the blown air speed from outlet 14 is low. As a result, the entire body of the person can be cooled without excessively cooling the body of the person.

### Embodiment 3

A vehicle seat air conditioning device according to this embodiment differs from the vehicle seat air conditioning device according to Embodiment 2 in that it is further determined whether the skin temperature of the person is less than a third predetermined temperature or not. In other respects, this embodiment is the same as Embodiment 2. The same components or features will be denoted by the same reference numerals and will not be described in detail.

In this embodiment, in the case where value (differential temperature) ΔT1 obtained by subtracting third temperature Tsk from first temperature T is less than the sixth predetermined temperature, when value (differential temperature) ΔT2 obtained by subtracting second temperature Ta from first temperature T is a second predetermined temperature or higher, or when value ΔT2 obtained by subtracting second temperature Ta from first temperature T is less than the second predetermined temperature and the third temperature is a third predetermined temperature or higher, controller 50 causes fan 30 to set the rate of rotation of fan 30 to a second rate of rotation greater than the first rate of rotation.

Furthermore, in the case where value ΔT1 obtained by subtracting third temperature Tsk from first temperature T is less than the sixth predetermined temperature, when value ΔT2 obtained by subtracting second temperature Ta from first temperature T is less than the second predetermined temperature and the third temperature is less than the third predetermined temperature, controller 50 causes fan 30 to set the rate of rotation of fan 30 to a third rate of rotation greater than the first rate of rotation and less than the second rate of rotation.

### <Process Operations>

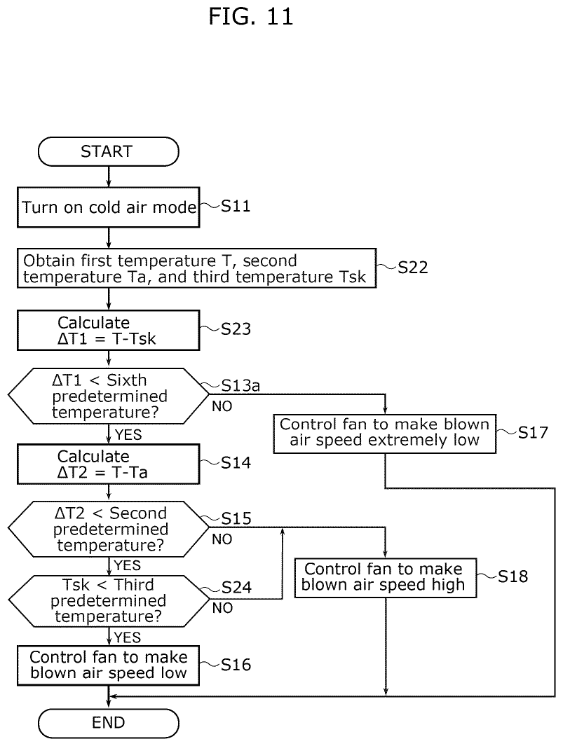

Next, process operations of vehicle seat air conditioning device 3 will be described with reference to FIG. 11. Of the process operations, the same processes as those in FIG. 10 are denoted by the same reference numerals, and descriptions thereof will be omitted as required.

FIG. 11 is a flowchart illustrating a process of vehicle seat air conditioning device 3 according to Embodiment 3.

As illustrated in FIG. 11, after performing the processing of Step S11, controller 50 of vehicle seat air conditioning device 3 obtains information indicating first temperature T, which is the temperature inside the vehicle detected by first temperature sensor 61, information indicating second temperature Ta, which is the temperature of air blown out from outlet 14 detected by second temperature sensor 62, and information indicating third temperature Tsk, which is the skin temperature of the person detected by infrared sensor 63 (S22).

Controller 50 then calculates differential temperature ΔT1 (S23).

Controller 50 then determines whether differential temperature ΔT1 is less than a sixth predetermined temperature or not (S13a).

When it is determined that differential temperature ΔT1 is the sixth predetermined temperature or higher (NO in S13a), controller 50 sets the rate of rotation of fan 30 to the first rate of rotation so that the blown air speed from outlet 14 is extremely low (S17).

Vehicle seat air conditioning device 3 then ends the process operations in FIG. 11.

When it is determined that differential temperature ΔT1 is less than the sixth predetermined temperature (YES in S13a), controller 50 calculates differential temperature ΔT2 (S14).

Controller 50 then determines whether differential temperature ΔT2 is less than a second predetermined temperature or not (S15). When it is determined that differential temperature ΔT2 is the second predetermined temperature or higher (NO in S15), controller 50 sets the rate of rotation of fan 30 to a second rate of rotation so that the blown air speed from outlet 14 is high (S18).

Vehicle seat air conditioning device 3 then ends the process operations in FIG. 11.

When it is determined that differential temperature ΔT2 is less than the second predetermined temperature (YES in S15), controller 50 determines whether third temperature Tsk is less than a third predetermined temperature or not (S24).

When it is determined that third temperature Tsk is the third predetermined temperature or higher (NO in S24), controller 50 controls fan 30 so that the blown air speed from outlet 14 is high (S18).

Vehicle seat air conditioning device 3 then ends the process operations in FIG. 11.

When it is determined that third temperature Tsk is less than the third predetermined temperature (YES in S24), controller 50 sets the rate of rotation of fan 30 to a third rate of rotation so that the blown air speed from outlet 14 is low (S16). Vehicle seat air conditioning device 3 then ends the process operations in FIG. 11.

Note that Step S13 in FIG. 7 may be used instead of Step S13a. In that case, controller 50 may determine whether first temperature T is less than the first predetermined temperature or not (S13). When it is determined that first temperature T is less than the first predetermined temperature, controller 50 may calculate differential temperature ΔT2 (S14). When it is determined that first temperature T is the first predetermined temperature or higher, controller 50 may set the rate of rotation of fan 30 to the first rate of rotation so that the blown air speed from outlet 14 is extremely low (S17).

### Advantageous Effects

Next, advantageous effects of vehicle seat air conditioning device 3 according to this embodiment will be described.

As described above, in the case where value (differential temperature) ΔT1 obtained by subtracting third temperature Tsk from first temperature T is less than the sixth predetermined temperature, when value (differential temperature) ΔT2 obtained by subtracting second temperature Ta from first temperature T is a second predetermined temperature or higher, or when value ΔT2 obtained by subtracting second temperature Ta from first temperature T is less than the second predetermined temperature and the third temperature is a third predetermined temperature or higher, controller 50 of vehicle seat air conditioning device 3 according to this embodiment causes fan 30 to set the rate of rotation of fan 30 to the second rate of rotation greater than the first rate of rotation, and when value ΔT2 obtained by subtracting second temperature Ta from first temperature T is less than the second predetermined temperature and the third temperature is less than the third predetermined temperature, controller 50 causes fan 30 to set the rate of rotation of fan 30 to the third rate of rotation greater than the first rate of rotation and less than the second rate of rotation.

According to this, when differential temperature ΔT2 is the second predetermined temperature or higher or when differential temperature ΔT2 is less than the second predetermined temperature and the third temperature is the third predetermined temperature or higher, the person seated on seat 1 may feel hot although the temperature of the air blown from outlet 14 is lower than the skin temperature of the person. Therefore, controller 50 sets the rate of rotation of fan 30 to the second rate of rotation so that the blown air speed from outlet 14 is high. As a result, the body of the person can be partially cooled.

When differential temperature ΔT2 is less than the second predetermined temperature and the third temperature is less than the third predetermined temperature, the inside of vehicle 2a may be effectively cooled by the air conditioner of vehicle 2a, and the temperature inside the vehicle (the first temperature) may be close to a target temperature. In that case, the temperature inside the vehicle is appropriate, so that the person seated on seat 1 may feel comfortable. Therefore, to avoid excessively cooling the body of the person, controller 50 sets the rate of rotation of fan 30 to the third rate of rotation so that the blown air speed from outlet 14 is low. As a result, the entire body of the person can be cooled without excessively cooling the body of the person.

Furthermore, in the case where the first temperature is less than the first predetermined temperature, when value ΔT2 obtained by subtracting second temperature Ta from first temperature T is the second predetermined temperature or higher, or when value ΔT2 obtained by subtracting second temperature Ta from first temperature T is less than the second predetermined temperature and the third temperature is the third predetermined temperature or higher, controller 50 of vehicle seat air conditioning device 3 according to this embodiment causes fan 30 to set the rate of rotation of fan 30 to the second rate of rotation greater than the first rate of rotation, and when value ΔT2 obtained by subtracting second temperature Ta from first temperature T is less than the second predetermined temperature and the third temperature is less than the third predetermined temperature, controller 50 causes fan 30 to set the rate of rotation of fan 30 to the third rate of rotation greater than the first rate of rotation and less than the second rate of rotation.

In this case, the same advantageous effects as described above are achieved.

### Embodiment 4

A vehicle seat air conditioning device according to this embodiment differs from the vehicle seat air conditioning device according to Embodiment 3 in that it is further determined whether the second temperature is less than a fourth predetermined temperature or not. In other respects, this embodiment is the same as Embodiment 3. The same components or features will be denoted by the same reference numerals and will not be described in detail.

In this embodiment, in the case where value (differential temperature) ΔT1 obtained by subtracting third temperature Tsk from first temperature T is less than the sixth predetermined temperature, when value (differential temperature) ΔT2 obtained by subtracting second temperature Ta from first temperature T is the second predetermined temperature or higher, or when value ΔT2 obtained by subtracting second temperature Ta from first temperature T is less than the second predetermined temperature and the second temperature is a forth predetermined temperature or higher, controller 50 causes fan 30 to set the rate of rotation of fan 30 to a second rate of rotation greater than the first rate of rotation.

Furthermore, in the case where value ΔT1 obtained by subtracting third temperature Tsk from first temperature T is less than the sixth predetermined temperature, value ΔT2 obtained by subtracting second temperature Ta from first temperature T is less than the second predetermined temperature and the second temperature is less than the fourth predetermined temperature, controller 50 causes fan 30 to set the rate of rotation of fan 30 to a third rate of rotation greater than the first rate of rotation and less than the second rate of rotation.

### <Process Operations>

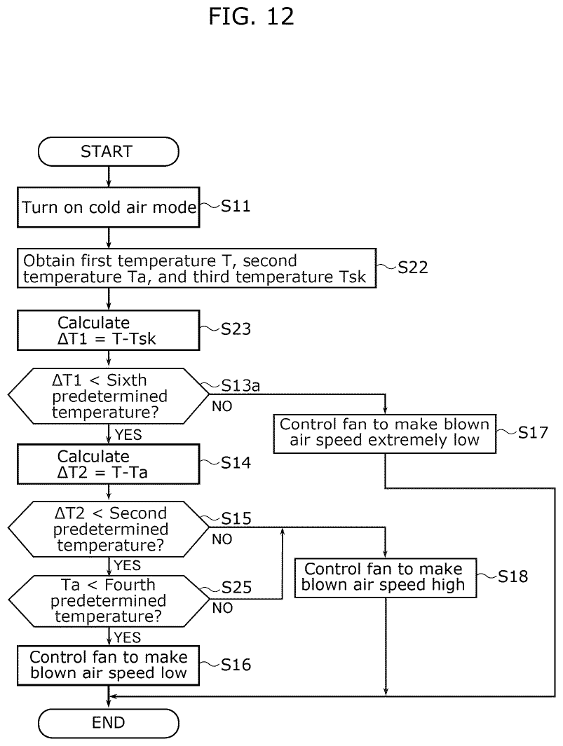

Next, process operations of vehicle seat air conditioning device 3 will be described with reference to FIG. 12. Of the process operations, the same processes as those in FIG. 11 are denoted by the same reference numerals, and descriptions thereof will be omitted as required.

FIG. 12 is a flowchart illustrating a process of vehicle seat air conditioning device 3 according to Embodiment 4.

As illustrated in FIG. 12, controller 50 of vehicle seat air conditioning device 3 first performs the process operations of Steps S11 to S15.

When it is determined that differential temperature ΔT2 is less than the second predetermined temperature (YES in S15), controller 50 determines whether second temperature Ta is less than a fourth predetermined temperature or not (S25).

When it is determined that second temperature Ta is the fourth predetermined temperature or higher (NO in S25), controller 50 sets the rate of rotation of fan 30 to the second rate of rotation so that the blown air speed from outlet 14 is high (S18).

Vehicle seat air conditioning device 3 then ends the process operations in FIG. 12.

When it is determined that second temperature Ta is less than the fourth predetermined temperature (YES in S25), controller 50 sets the rate of rotation of fan 30 to the third rate of rotation so that the blown air speed from outlet 14 is low (S16).

Vehicle seat air conditioning device 3 then ends the process operations in FIG. 12.

Note that Step S13 in FIG. 7 may be used instead of Step S13a. In that case, controller 50 may determine whether first temperature T is less than the first predetermined temperature or not (S13). When it is determined that first temperature T is less than the first predetermined temperature, controller 50 may calculate differential temperature ΔT2 (S14). When it is determined that first temperature T is the first predetermined temperature or higher, controller 50 may set the rate of rotation of fan 30 to the first rate of rotation so that the blown air speed from outlet 14 is extremely low (S17).

### Advantageous Effects

Next, advantageous effects of vehicle seat air conditioning device 3 according to this embodiment will be described.

As described above, in the case where value (differential temperature) ΔT1 obtained by subtracting third temperature Tsk from first temperature T is less than the sixth predetermined temperature, when value (differential temperature) ΔT2 obtained by subtracting second temperature Ta from first temperature T is a second predetermined temperature or higher, or when value ΔT2 obtained by subtracting second temperature Ta from first temperature T is less than the second predetermined temperature and the second temperature is a fourth predetermined temperature or higher, controller 50 of vehicle seat air conditioning device 3 according to this embodiment causes fan 30 to set the rate of rotation of fan 30 to the second rate of rotation greater than the first rate of rotation, and when value ΔT2 obtained by subtracting second temperature Ta from first temperature T is less than the second predetermined temperature and the second temperature is less than the fourth predetermined temperature, controller 50 causes fan 30 to set the rate of rotation of fan 30 to the third rate of rotation greater than the first rate of rotation and less than the second rate of rotation.

According to this, when differential temperature ΔT2 is the second predetermined temperature or higher or when differential temperature ΔT2 is less than the second predetermined temperature and the second temperature is the fourth predetermined temperature or higher, the person seated on seat 1 may feel hot although the temperature of the air blown from outlet 14 is lower than the skin temperature of the person. Therefore, controller 50 sets the rate of rotation of fan 30 to the second rate of rotation so that the blown air speed from outlet 14 is high. As a result, the body of the person can be partially cooled.

When differential temperature ΔT2 is less than the second predetermined temperature and the second temperature is less than the fourth predetermined temperature, the inside of vehicle 2a may be effectively cooled by the air conditioner of vehicle 2a, and the temperature inside the vehicle (the first temperature) may be close to a target temperature. In that case, the temperature inside the vehicle is appropriate, so that the person seated on seat 1 may feel comfortable. Therefore, to avoid excessively cooling the body of the person, controller 50 sets the rate of rotation of fan 30 to the third rate of rotation so that the blown air speed from outlet 14 is low. As a result, the entire body of the person can be cooled without excessively cooling the body of the person.

Furthermore, in the case where the first temperature is less than the first predetermined temperature, when value ΔT2 obtained by subtracting second temperature Ta from first temperature T is the second predetermined temperature or higher, or when value ΔT2 obtained by subtracting second temperature Ta from first temperature T is less than the second predetermined temperature and the second temperature is the fourth predetermined temperature or higher, controller 50 of vehicle seat air conditioning device 3 according to this embodiment causes fan 30 to set the rate of rotation of fan 30 to the second rate of rotation greater than the first rate of rotation, and when value ΔT2 obtained by subtracting second temperature Ta from first temperature T is less than the second predetermined temperature and the second temperature is less than the fourth predetermined temperature, controller 50 causes fan 30 to set the rate of rotation of fan 30 to the third rate of rotation greater than the first rate of rotation and less than the second rate of rotation.

In this case, the same advantageous effects as described above are achieved.

### Embodiment 5

A vehicle seat air conditioning device according to this embodiment differs from the vehicle seat air conditioning device according to Embodiment 4 in that it is determined whether a value obtained by subtracting target temperature Tset from second temperature Ta is less than a fifth predetermined temperature or not. In other respects, this embodiment is the same as Embodiment 4. The same components or features will be denoted by the same reference numerals and will not be described in detail.

In this embodiment, the air conditioner of vehicle 2a outputs set target temperature Tset to controller 50.

In the case where value (differential temperature) ΔT1 obtained by subtracting third temperature Tsk from first temperature T is less than the sixth predetermined temperature, when value (differential temperature) ΔT2 obtained by subtracting second temperature Ta from first temperature T is the second predetermined temperature or higher, or when value ΔT2 obtained by subtracting second temperature Ta from first temperature T is less than the second predetermined temperature and value ΔT3 obtained by subtracting target temperature Tset from second temperature Ta is a fifth predetermined temperature or higher, controller 50 causes fan 30 to set the rate of rotation of fan 30 to a second rate of rotation greater than the first rate of rotation.

Furthermore, in the case where value ΔT1 obtained by subtracting third temperature Tsk from first temperature T is less than the sixth predetermined temperature, when value ΔT2 obtained by subtracting second temperature Ta from first temperature T is less than the second predetermined temperature and value (differential temperature) ΔT3 obtained by subtracting target temperature Tset from second temperature Ta is less than the fifth predetermined temperature, controller 50 causes fan 30 to set the rate of rotation of fan 30 to a third rate of rotation greater than the first rate of rotation and less than the second rate of rotation.

### <Process Operations>

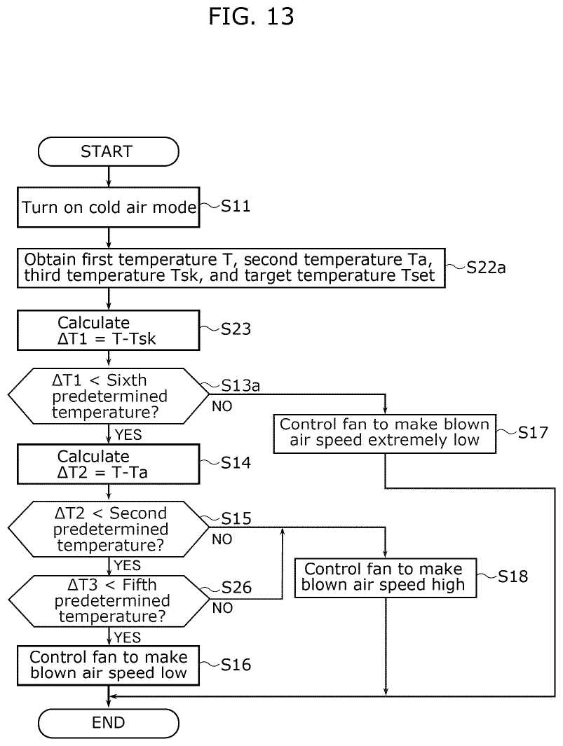

Next, process operations of vehicle seat air conditioning device 3 will be described with reference to FIG. 13. Of the process operations, the same processes as those in FIG. 12 are denoted by the same reference numerals, and descriptions thereof will be omitted as required.

FIG. 13 is a flowchart illustrating a process of vehicle seat air conditioning device 3 according to Embodiment 5.

Controller 50 of vehicle seat air conditioning device 3 first turns on the cold air mode (S11). In this way, controller 50 starts controlling fan 30.

Controller 50 then obtains information indicating first temperature T, which is the temperature inside the vehicle detected by first temperature sensor 61, information indicating second temperature Ta, which is the temperature of air blown out from outlet 14 detected by second temperature sensor 62, information indicating third temperature Tsk, which is the skin temperature of the person detected by infrared sensor 63, and information indicating target temperature Tset of the air conditioner of vehicle 2a (S22a).

Controller 50 then calculates differential temperature ΔT1 (S23).

Controller 50 then determines whether differential temperature ΔT1 is less than the sixth predetermined temperature or not (S13a).

When it is determined that differential temperature ΔT1 is the sixth predetermined temperature or higher (NO in S13a), controller 50 sets the rate of rotation of fan 30 to the first rate of rotation so that the blown air speed from outlet 14 is extremely low (S17).

Vehicle seat air conditioning device 3 then ends the process operations in FIG. 13.

When it is determined that differential temperature ΔT1 is less than the sixth predetermined temperature (YES in S13a), controller 50 calculates differential temperature ΔT2 (S14).

Controller 50 then determines whether differential temperature ΔT2 is less than the second predetermined temperature or not (S15).

When it is determined that differential temperature ΔT2 is less than the second predetermined temperature (YES in S15), controller 50 determines whether differential temperature ΔT3 is less than a fifth predetermined temperature or not (S26).

When it is determined that differential temperature ΔT3 is the fifth predetermined temperature or higher (NO in S26), controller 50 sets the rate of rotation of fan 30 to the second rate of rotation so that the blown air speed from outlet 14 is high (S18).

Vehicle seat air conditioning device 3 then ends the process operations in FIG. 13.

When it is determined that differential temperature ΔT3 is less than the fifth predetermined temperature (YES in S26), controller 50 sets the rate of rotation of fan 30 to the third rate of rotation so that the blown air speed from outlet 14 is low (S16).

Note that Step S13 in FIG. 7 may be used instead of Step S13a. In that case, controller 50 may determine whether first temperature T is less than the first predetermined temperature or not (S13). When it is determined that first temperature T is less than the first predetermined temperature, controller 50 may calculate differential temperature ΔT2 (S14). When it is determined that first temperature T is the first predetermined temperature or higher, controller 50 may set the rate of rotation of fan 30 to the first rate of rotation so that the blown air speed from outlet 14 is extremely low (S17).

### Advantageous Effects

Next, advantageous effects of vehicle seat air conditioning device 3 according to this embodiment will be described.

As described above, with vehicle seat air conditioning device 3 according to this embodiment, in the case where value ΔT1 obtained by subtracting third temperature Tsk from first temperature T is less than the sixth predetermined temperature, when value ΔT2 obtained by subtracting second temperature Ta from first temperature T is the second predetermined temperature or higher, or when value ΔT2 obtained by subtracting second temperature Ta from first temperature T is less than the second predetermined temperature and value (differential temperature) ΔT3 obtained by subtracting target temperature Tset from second temperature Ta is the fifth predetermined temperature or higher, controller 50 causes fan 30 to set the rate of rotation of fan 30 to the second rate of rotation greater than the first rate of rotation, and when value ΔT2 obtained by subtracting second temperature Ta from first temperature T is less than the second predetermined temperature and value ΔT3 obtained by subtracting target temperature Tset from second temperature Ta is less than the fifth predetermined temperature, controller 50 causes fan 30 to set the rate of rotation of fan 30 to the third rate of rotation greater than the first rate of rotation and less than the second rate of rotation.

According to this, when differential temperature ΔT2 is the second predetermined temperature or higher or when differential temperature ΔT2 is less than the second predetermined temperature and differential temperature ΔT3 is the fifth predetermined temperature or higher, the person seated on seat 1 may feel hot although the temperature of the air blown from outlet 14 is lower than the skin temperature of the person. Therefore, controller 50 sets the rate of rotation of fan 30 to the second rate of rotation so that the blown air speed from outlet 14 is high. As a result, the body of the person can be partially cooled.

When differential temperature ΔT2 is less than the second predetermined temperature and the differential temperature ΔT3 is less than the fifth predetermined temperature, the inside of vehicle 2a may be effectively cooled by the air conditioner of vehicle 2a, and the temperature inside the vehicle (the first temperature) may be close to the target temperature. In that case, the temperature inside the vehicle is appropriate, so that the person seated on seat 1 may feel comfortable. Therefore, to avoid excessively cooling the body of the person, controller 50 sets the rate of rotation of fan 30 to the third rate of rotation so that the blown air speed from outlet 14 is low. As a result, the entire body of the person can be cooled without excessively cooling the body of the person.

Furthermore, in the case where the first temperature is less than the first predetermined temperature, when value ΔT2 obtained by subtracting second temperature Ta from first temperature T is the second predetermined temperature or higher, or when value ΔT2 obtained by subtracting second temperature Ta from first temperature T is less than the second predetermined temperature and value ΔT3 obtained by subtracting target temperature Tset from second temperature Ta is the fifth predetermined temperature or higher, controller 50 of vehicle seat air conditioning device 3 according to this embodiment causes fan 30 to set the rate of rotation of fan 30 to the second rate of rotation greater than the first rate of rotation, and when value ΔT2 obtained by subtracting second temperature Ta from first temperature T is less than the second predetermined temperature and value ΔT3 obtained by subtracting target temperature Tset from second temperature Ta is less than the fifth predetermined temperature, controller 50 causes fan 30 to set the rate of rotation of fan 30 to the third rate of rotation greater than the first rate of rotation and less than the second rate of rotation.

In this case, the same advantageous effects as described above are achieved.

### Other Variations

Vehicle seat air conditioning devices according to the present disclosure have been described above with reference to Embodiments 1 to 5, the present disclosure is not limited to these Embodiments 1 to 5. Various modifications that occur to those skilled in the art can be made to Embodiments 1 to 5 without departing from the spirit of the present disclosure, and such modifications are also included in the scope of the present disclosure.

For example, the controller and other components included in the vehicle seat air conditioning device according to any of Embodiments 1 to 5 described above are typically implemented as LSIs, which are integrated circuits. These integrated circuits may be implemented as discrete chips, or some or all of these integrated circuits may be integrated into one chip.

The components need not be implemented as LSIs but may be implemented as dedicated circuits or general-purpose processors. A field programmable gate array (FPGA) that can be programmed after LSI manufacture or a reconfigurable processor that can reconfigure the connection or configuration of circuit cells in the LSI.

Each component of the vehicle seat air conditioning device according to any of Embodiments 1 to 5 may be implemented by dedicated hardware or may be implemented by executing a software program corresponding to the component. Each component may be implemented by a program executer, such as a CPU or a processor, reading and executing a software program stored in a storage medium, such as a hard disk or a semiconductor memory.

All the numerical values used in the above description are merely examples for specifically describing the present disclosure, and Embodiments 1 to 5 of the present disclosure are not limited to the numerical values illustrated.

Divisions of functional blocks in the block diagrams are also merely examples. A plurality of functional blocks may be integrated into one functional block, one functional block may be divided into a plurality of blocks, or some functions of a functional block may be transferred to another functional block. Furthermore, functions of a plurality of functional blocks having similar functions may be implemented in parallel or in a time division manner by one piece of hardware or software.

The sequences of steps in flowcharts are merely examples for specifically describing the present disclosure, and other sequences of steps than those described above are possible. Some of the steps may be implemented at the same time (in parallel) with other steps.

Note that various modifications of Embodiments 1 to 5 described above that occur to those skilled in the art and any implementations achieved by arbitrarily combining components or functions according to Embodiments 1 to 5 without departing from the spirit of the present disclosure are also included in the scope of the present disclosure.

### (Supplementary Notes)

The following are characteristics of vehicle seat air conditioning devices described above with reference to Embodiments 1 to 5.

### <Technique 1>

A vehicle seat air conditioning device for use in a seat including a seat back and a seat cushion, the vehicle seat air conditioning device comprising:
a fan built in the seat;
a controller that controls the fan; and
an outlet that blows out air from a surface of the seat back, the air being sent by the fan and guided through a flow path formed in the seat back, wherein
the outlet is provided with a wind direction adjuster including one or more plates that adjust a direction of air blown out from the outlet,
the one or more plates are disposed in an orientation completely or substantially parallel to or tilted with respect to a central axis of the flow path along which air to be blown out from the outlet flows, and
the controller controls a rate of rotation of the fan based on a first temperature that is a temperature inside a vehicle and a second temperature that is a temperature of air blown out from the outlet.

### <Technique 2>

The vehicle seat air conditioning device according to Technique 1, wherein
the outlet opens to face in a vertically upward direction, and
the one or more plates are disposed in an orientation tilted with respect to the central axis of the flow path.

### <Technique 3>

The vehicle seat air conditioning device according to Technique 1, wherein
the outlet opens to face in a horizontal direction, and
the one or more plates are disposed in an orientation completely or substantially parallel to the central axis of the flow path.

### <Technique 4>

The vehicle seat air conditioning device according to any one of Techniques 1 to 3, wherein
when the first temperature is a first predetermined temperature or higher, the controller sets the rate of rotation of the fan to a first rate of rotation; and
when the first temperature is lower than the first predetermined temperature, the controller sets the rate of rotation of the fan to a rate of rotation greater than the first rate of rotation.

### <Technique 5>

The vehicle seat air conditioning device according to Technique 4, wherein
in a case where the first temperature is lower than the first predetermined temperature:
   when a value ΔT2 obtained by subtracting the second temperature, Ta, from the first temperature, T, is a second predetermined temperature or higher, the controller causes the fan to set the rate of rotation of the fan to a second rate of rotation greater than the first rate of rotation; and
   when the value ΔT2 is less than the second predetermined temperature, the controller causes the fan to set the rate of rotation of the fan to a third rate of rotation greater than the first rate of rotation and less than the second rate of rotation.

### <Technique 6>

The vehicle seat air conditioning device according to Technique 4, wherein
(i) when a value ΔT2 obtained by subtracting the second temperature, Ta, from the first temperature, T, is a second predetermined temperature or higher, or (ii) when the value ΔT2 is less than the second predetermined temperature and a third temperature that is a human skin temperature is a third predetermined temperature or higher, the controller causes the fan to set the rate of rotation of the fan to a second rate of rotation greater than the first rate of rotation; and
   when the value ΔT2 is less than the second predetermined temperature and the third temperature is lower than the third predetermined temperature, the controller causes the fan to set the rate of rotation of the fan to a third rate of rotation greater than the first rate of rotation and less than the second rate of rotation.

### <Technique 7>

The vehicle seat air conditioning device according to Technique 4, wherein
in a case where the first temperature is lower than the first predetermined temperature:
   (i) when a value ΔT2 obtained by subtracting the second temperature, Ta, from the first temperature, T, is a second predetermined temperature or higher, or (ii) when the value ΔT2 is less than the second predetermined temperature and the second temperature is a fourth predetermined temperature or higher, the controller causes the fan to set the rate of rotation of the fan to a second rate of rotation greater than the first rate of rotation;
   when the value ΔT2 is less than the second predetermined temperature and the second temperature is lower than the fourth predetermined temperature, the controller causes the controller to set the rate of rotation of the fan to a third rate of rotation greater than the first rate of rotation and less than the second rate of rotation.

### <Technique 8>

The vehicle seat air conditioning device according to Technique 4, wherein
in a case where the first temperature is lower than the first predetermined temperature:
   (i) when a value ΔT2 obtained by subtracting the second temperature, Ta, from the first temperature, T, is a second predetermined temperature or higher, or (ii) when the value ΔT2 is less than the second predetermined temperature and a value ΔT3 obtained by subtracting a target temperature Tset from the second temperature Ta is a fifth predetermined temperature or higher, the controller causes the fan to set the rate of rotation of the fan to a second rate of rotation greater than the first rate of rotation; and
   when the value ΔT2 is less than the second predetermined temperature and the value ΔT3 is lower than the fifth predetermined temperature, the controller causes the fan to set the rate of rotation of the fan to a third rate of rotation greater than the first rate of rotation and less than the second rate of rotation.

### <Technique 9>

The vehicle seat air conditioning device according to any one of Techniques 1 to 3, wherein
when a value ΔT1 obtained by subtracting a third temperature Tsk that is a human skin temperature from the first temperature, T, is a sixth predetermined temperature or higher, the controller causes the fan to set the rate of rotation of the fan to a first rate of rotation, and
when the value ΔT1 is less than the sixth predetermined temperature, the controller causes the fan to set the rate of rotation of the fan to a rate of rotation greater than the first rate of rotation.

### <Technique 10>

The vehicle seat air conditioning device according to Technique 9, wherein
in a case where the value ΔT1 is less than the sixth predetermined temperature:
   when a value ΔT2 obtained by subtracting the second temperature Ta from the first temperature T is a second predetermined temperature or higher, the controller causes the fan to set the rate of rotation of the fan to a second rate of rotation greater than the first rate of rotation; and
   when the value ΔT2 is less than the second predetermined temperature, the controller causes the fan to set the rate of rotation of the fan to a third rate of rotation greater than the first rate of rotation and less than the second rate of rotation.

### <Technique 11>

The vehicle seat air conditioning device according to Technique 9, wherein
in a case where the value ΔT1 is less than the sixth predetermined temperature:
   (i) when a value ΔT2 obtained by subtracting the second temperature, Ta, from the first temperature T is a second predetermined temperature or higher, or (ii) when the value ΔT2 is less than the second predetermined temperature and the third temperature is a third predetermined temperature or higher, the controller causes the fan to set the rate of rotation of the fan to a second rate of rotation greater than the first rate of rotation; and
   when the value ΔT2 is less than the second predetermined temperature and the third temperature is lower than the third predetermined temperature, the controller causes the fan to set the rate of rotation of the fan to a third rate of rotation greater than the first rate of rotation and less than the second rate of rotation.

### <Technique 12>

The vehicle seat air conditioning device according to Technique 9, wherein
in a case where the value ΔT1 is less than the sixth predetermined temperature:
   (i) when a value ΔT2 obtained by subtracting the second temperature, Ta, from the first temperature T is a second predetermined temperature or higher, or (ii) when the value ΔT2 is less than the second predetermined temperature and the second temperature is a forth predetermined temperature or higher, the controller causes the fan to set the rate of rotation of the fan to a second rate of rotation greater than the first rate of rotation; and
   when the value ΔT2 is less than the second predetermined temperature and the second temperature is lower than the fourth predetermined temperature, the controller causes the fan to set the rate of rotation of the fan to a third rate of rotation greater than the first rate of rotation and less than the second rate of rotation.

### <Technique 13>

The vehicle seat air conditioning device according to Technique 9, wherein
in a case where the value ΔT1 is less than the sixth predetermined temperature:
   (i) when a value ΔT2 obtained by subtracting the second temperature, Ta, from the first temperature T is a second predetermined temperature or higher, or (ii) when the value ΔT2 is less than the second predetermined temperature and a value ΔT3 obtained by subtracting a target temperature Tset from the second temperature Ta is a fifth predetermined temperature or higher, the controller causes the fan to set the rate of rotation of the fan to a second rate of rotation greater than the first rate of rotation; and
   when the value ΔT2 is less than the second predetermined temperature and the value ΔT3 is less than the fifth predetermined temperature, the controller causes the fan to set the rate of rotation of the fan to a third rate of rotation greater than the first rate of rotation and less than the second rate of rotation.

### <Technique 14>

The vehicle seat air conditioning device according to any one of Techniques 1 to 13, wherein
each of the one or more plates includes a protrusion on one surface of the plate, the protrusion being capable of guiding air.

### <Technique 15>

The vehicle seat air conditioning device according to Technique 14, wherein
the protrusion extends in a depth direction of the plate along the central axis and is disposed on one surface of the plate such that an extension line in a direction in which the protrusion extends does not intersect with a person seated on the seat.

### <Technique 16>

The vehicle seat air conditioning device according to Technique 14 or 15, wherein
when the plate is divided into a front region and a back region at a midpoint of a length of the plate in a depth direction along the central axis, the protrusion is disposed in the back region.

### <Technique 17>

The vehicle seat air conditioning device according to any one of Techniques 1 to 16, wherein
the orientation of the one or more plates changes in accordance with a volume of air that passes through the wind direction adjuster or a temperature of air that passes through the wind direction adjuster.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2022-032675 filed on Mar. 3, 2022 and Japanese Patent Application No. 2022-158988 filed on Sep. 30, 2022, and PCT International Application No. PCT/JP2023/005262 filed on Feb. 15, 2023.

### INDUSTRIAL APPLICABILITY

The present disclosure can be applied to a seat, a sofa, or the like for a mobile body, such as a vehicle.

1. A vehicle seat air conditioning device for use in a seat including a seat back and a seat cushion, the vehicle seat air conditioning device comprising:
a fan built in the seat;
a controller that controls the fan; and
an outlet that blows out air from a surface of the seat back, the air being sent by the fan and guided through a flow path formed in the seat back, wherein
the outlet is provided with a wind direction adjuster including one or more plates that adjust a direction of air blown out from the outlet,
the one or more plates are disposed in an orientation completely or substantially parallel to or tilted with respect to a central axis of the flow path along which air to be blown out from the outlet flows, and
the controller controls a rate of rotation of the fan based on a first temperature that is a temperature inside a vehicle and a second temperature that is a temperature of air blown out from the outlet.

2. The vehicle seat air conditioning device according to claim 1, wherein
the outlet opens to face in a vertically upward direction, and
the one or more plates are disposed in an orientation tilted with respect to the central axis of the flow path.

3. The vehicle seat air conditioning device according to claim 1, wherein
the outlet opens to face in a horizontal direction, and
the one or more plates are disposed in an orientation completely or substantially parallel to the central axis of the flow path.

4. The vehicle seat air conditioning device according to claim 1, wherein
when the first temperature is a first predetermined temperature or higher, the controller sets the rate of rotation of the fan to a first rate of rotation; and
when the first temperature is lower than the first predetermined temperature, the controller sets the rate of rotation of the fan to a rate of rotation greater than the first rate of rotation.

5. The vehicle seat air conditioning device according to claim 4, wherein
in a case where the first temperature is lower than the first predetermined temperature:
when a value ΔT2 obtained by subtracting the second temperature, Ta, from the first temperature, T, is a second predetermined temperature or higher, the controller causes the fan to set the rate of rotation of the fan to a second rate of rotation greater than the first rate of rotation; and
when the value ΔT2 is less than the second predetermined temperature, the controller causes the fan to set the rate of rotation of the fan to a third rate of rotation greater than the first rate of rotation and less than the second rate of rotation.

6. The vehicle seat air conditioning device according to claim 4, wherein
in a case where the first temperature is lower than the first predetermined temperature:
(i) when a value ΔT2 obtained by subtracting the second temperature, Ta, from the first temperature, T, is a second predetermined temperature or higher, or (ii) when the value ΔT2 is less than the second predetermined temperature and a third temperature that is a human skin temperature is a third predetermined temperature or higher, the controller causes the fan to set the rate of rotation of the fan to a second rate of rotation greater than the first rate of rotation; and
when the value ΔT2 is less than the second predetermined temperature and the third temperature is lower than the third predetermined temperature, the controller causes the fan to set the rate of rotation of the fan to a third rate of rotation greater than the first rate of rotation and less than the second rate of rotation.

7. The vehicle seat air conditioning device according to claim 4, wherein
in a case where the first temperature is lower than the first predetermined temperature:
(i) when a value ΔT2 obtained by subtracting the second temperature, Ta, from the first temperature, T, is a second predetermined temperature or higher, or (ii) when the value ΔT2 is less than the second predetermined temperature and the second temperature is a fourth predetermined temperature or higher, the controller causes the fan to set the rate of rotation of the fan to a second rate of rotation greater than the first rate of rotation;
when the value ΔT2 is less than the second predetermined temperature and the second temperature is lower than the fourth predetermined temperature, the controller causes the controller to set the rate of rotation of the fan to a third rate of rotation greater than the first rate of rotation and less than the second rate of rotation.

8. The vehicle seat air conditioning device according to claim 4, wherein
in a case where the first temperature is lower than the first predetermined temperature:
(i) when a value ΔT2 obtained by subtracting the second temperature, Ta, from the first temperature, T, is a second predetermined temperature or higher, or (ii) when the value ΔT2 is less than the second predetermined temperature and a value ΔT3 obtained by subtracting a target temperature Tset from the second temperature Ta is a fifth predetermined temperature or higher, the controller causes the fan to set the rate of rotation of the fan to a second rate of rotation greater than the first rate of rotation; and
when the value ΔT2 is less than the second predetermined temperature and the value ΔT3 is lower than the fifth predetermined temperature, the controller causes the fan to set the rate of rotation of the fan to a third rate of rotation greater than the first rate of rotation and less than the second rate of rotation.

9. The vehicle seat air conditioning device according to claim 1, wherein
when a value ΔT1 obtained by subtracting a third temperature Tsk that is a human skin temperature from the first temperature, T, is a sixth predetermined temperature or higher, the controller causes the fan to set the rate of rotation of the fan to a first rate of rotation, and
when the value ΔT1 is less than the sixth predetermined temperature, the controller causes the fan to set the rate of rotation of the fan to a rate of rotation greater than the first rate of rotation.

10. The vehicle seat air conditioning device according to claim 9, wherein
in a case where the value ΔT1 is less than the sixth predetermined temperature:
when a value ΔT2 obtained by subtracting the second temperature Ta from the first temperature T is a second predetermined temperature or higher, the controller causes the fan to set the rate of rotation of the fan to a second rate of rotation greater than the first rate of rotation; and
when the value ΔT2 is less than the second predetermined temperature, the controller causes the fan to set the rate of rotation of the fan to a third rate of rotation greater than the first rate of rotation and less than the second rate of rotation.

11. The vehicle seat air conditioning device according to claim 9, wherein
in a case where the value ΔT1 is less than the sixth predetermined temperature:
(i) when a value ΔT2 obtained by subtracting the second temperature, Ta, from the first temperature T is a second predetermined temperature or higher, or (ii) when the value ΔT2 is less than the second predetermined temperature and the third temperature is a third predetermined temperature or higher, the controller causes the fan to set the rate of rotation of the fan to a second rate of rotation greater than the first rate of rotation; and
when the value ΔT2 is less than the second predetermined temperature and the third temperature is lower than the third predetermined temperature, the controller causes the fan to set the rate of rotation of the fan to a third rate of rotation greater than the first rate of rotation and less than the second rate of rotation.

12. The vehicle seat air conditioning device according to claim 9, wherein
in a case where the value ΔT1 is less than the sixth predetermined temperature:
(i) when a value ΔT2 obtained by subtracting the second temperature, Ta, from the first temperature T is a second predetermined temperature or higher, or (ii) when the value ΔT2 is less than the second predetermined temperature and the second temperature is a forth predetermined temperature or higher, the controller causes the fan to set the rate of rotation of the fan to a second rate of rotation greater than the first rate of rotation; and
when the value ΔT2 is less than the second predetermined temperature and the second temperature is lower than the fourth predetermined temperature, the controller causes the fan to set the rate of rotation of the fan to a third rate of rotation greater than the first rate of rotation and less than the second rate of rotation.

13. The vehicle seat air conditioning device according to claim 9, wherein
in a case where the value ΔT1 is less than the sixth predetermined temperature:
(i) when a value ΔT2 obtained by subtracting the second temperature, Ta, from the first temperature T is a second predetermined temperature or higher, or (ii) when the value ΔT2 is less than the second predetermined temperature and a value ΔT3 obtained by subtracting a target temperature Tset from the second temperature Ta is a fifth predetermined temperature or higher, the controller causes the fan to set the rate of rotation of the fan to a second rate of rotation greater than the first rate of rotation; and
when the value ΔT2 is less than the second predetermined temperature and the value ΔT3 is less than the fifth predetermined temperature, the controller causes the fan to set the rate of rotation of the fan to a third rate of rotation greater than the first rate of rotation and less than the second rate of rotation.

14. The vehicle seat air conditioning device according to claim 1, wherein
each of the one or more plates includes a protrusion on one surface of the plate, the protrusion being capable of guiding air.

15. The vehicle seat air conditioning device according to claim 14, wherein
the protrusion extends in a depth direction of the plate along the central axis and is disposed on one surface of the plate such that an extension line in a direction in which the protrusion extends does not intersect with a person seated on the seat.

16. The vehicle seat air conditioning device according to claim 14, wherein
when the plate is divided into a front region and a back region at a midpoint of a length of the plate in a depth direction along the central axis, the protrusion is disposed in the back region.

17. The vehicle seat air conditioning device according to claim 1, wherein
the orientation of the one or more plates changes in accordance with a volume of air that passes through the wind direction adjuster or a temperature of air that passes through the wind direction adjuster.
